(19) United States
(12) Patent Application Publication
(10) Pub. No.: US 2019/0010924 A1
(43) Pub. Date: Jan. 10, 2019

(54) METHOD FOR CONTROLLING A MACHINE OR PROCESS WITH INCREASED SAFETY

(71) Applicant: Moog Unna GmbH, Unna (DE)

(72) Inventors: Tobias Theopold, Dortmund (DE); Thomas Wiesenthal, Arnsberg (DE)

(21) Appl. No.: 16/064,912

(22) PCT Filed: Dec. 23, 2016
(86) PCT No.: PCT/EP2016/082585

§ 371 Date: Jun. 21, 2018

(30) Foreign Application Priority Data
Dec. 23, 2015 (GB) 1522770.5

(51) Int. Cl. F03D 7/04; G05B 19/042; F03D 7/02

(52) U.S. Cl. CPC F03D 7/047; G05B 19/0428; F03D 7/0224; F03D 7/0204; G05B 2219/2619; F05B 2270/329; F05B 2270/328; F05B 2270/504; F05B 2240/21; F05B 2220/706; F05B 2270/101; G05B 2219/23289

(57) ABSTRACT

A method for controlling a wind turbine comprising a first control unit controlling the wind turbine or a part of the wind turbine, the first control unit having a first number of first states. In order to improve the safety integrity level of the wind tur bine, the wind turbine further comprises a second control unit for controlling the first control unit, the second control unit having a second number of second states whereby the number of the second states of the second control unit is lower than the number of the first states of the first control unit. The second control unit maps to each second state a specific states of the number of first states of the first control unit as a target state and allows only a pre-defined set of transitions between the second states of the second control unit.

The present invention relates generally to the control of machine and processes, and particularly, to systems and methods for controlling wind turbines.

### BACKGROUND OF THE INVENTION

A machine in general is a tool or a device that contains one or more parts that use energy to perform an intended action. A process in engineering generally is defined as a series of interrelated tasks that together transform inputs to outputs, such for example controlling the flight path of an airplane. If a machine or a process runs out of hand it causes a hazard for the machine itself, for persons operating the machine, using the machine for example as a passenger, or to innocent bystanders. With increasing complexity of a machine or a process the risk that controlling a machine or a process may fail increases over proportionally to the complexity of the machine or process.

Wind turbines, for example, are used for the conversion of kinetic energy into electrical energy. A wind turbine basically comprises a rotor, including a rotatable hub, at least one rotor blade, a nacelle, which accommodates an electric generator and often a gearbox. The nacelle is rotatable mounted on a tower, so that depending on the direction of the wind, the nacelle can be rotated into the wind, such that the at least one rotor blade directly faces the wind. At present the dominating design of a wind turbine has three rotor blades. Especially in high-power wind turbines, each rotor blade includes a pitch adjustment mechanism configured to rotate each rotor blade about its pitch axis. By rotating the rotor blades about their pitch axis, the lift produced by the wind streaming around the blades and thus the rotational speed of the hub can be controlled.

The control of a wind turbine is quite complex so that usually a controller for controlling the wind turbine is software controlled. The power acting on a wind turbine is considerably high, so that a wrong command not only could destroy the wind turbine but also is a thread to health and life of a person working at or in the wind turbine or even to neighbours or casual bystanders, in the event the wind turbine disintegrates.

It is therefore an object of the invention to increase the safety, especially the functional safety of machines and processes, such as the safety of a wind turbine. Functional safety of a system is defined that the system is operating correctly in response to its inputs, including the safe management of likely operator errors, hardware failures and environmental changes.

This object is achieved by a method for controlling a machine or a process comprising a first control unit having a first number of first states and being in a current first state which is one of the number of first states, whereby the first control unit is adapted to transition from the current first state a another first state of the number of first states in response to a first input condition. The machine or process further comprises a second control unit for controlling the first control unit, the second control unit having a second number of second states and being in a current second state. The second control unit is adapted to transition from one state of the number of second states to another state of the number of second states in response to a second input condition. The method is based on an attribution list which comprises for each second state of the second control unit a first target state that is attributed to the respective second state. It further comprises set of pre-defined transitions between the second states of the second control unit and for each pre-defined transition a set of pre-defined actions. The method comprises receiving a second input condition as a second target state to which the second control unit shall transition from the current second state and checking if a transition from the current second state to the second target state is included in the set of pre-defined transitions; in the event the received second input condition is a transition from the current second state to the second target state that is included in the set of pre-defined transitions, performing the set of predefined actions which initiates the first control unit to transition to the first target state; supervising the first control unit if it transits to the first target state. In case the first control unit has completed a transition to the target state the current second state is changed to the second target state.

In one embodiment the number of the second states of the second control unit is lower than the number of the first states of the first control unit. This helps to reduce the complexity of the monitored first control unit and thus increase the safety of the machine or process. In another embodiment, where the first control unit is for example of a simple design, additional states may be added, for example by implementing and monitoring additional sensors. This is another way to increase the safety of a machine or a process by maintaining an existing controller.

The input condition that triggers a transition from one state to another state may be a command initiated by an operator of the machine or the process or a central control unit sending control commands or signals. In other cases the input condition may be signals or measurement data received from sensors etc., which are controlling the machine or the process respectively.

The set of pre-defined actions could comprise multiple actions, a single action, or even no action. One example for an action is a command that the second control unit sends to the first control unit for initiating the first control unit to transition to the first target state. The predefined action may alternatively or additionally comprise modifying received commands before forwarding the modified commands to the first control unit, modifying data that the first control unit is evaluating and on which the action of the first control unit is based on or takes into account, or invoking a control signal that is controlling the first control unit, to name a few. The control signal may be a signal to block or inhibit any action performed by the first control unit, including shutting down the machine or process.

The first target state may be chosen as one of the first states of the first control unit. Alternatively, or in addition the second control unit may read the signal of at least one sensor and compares this signal to a target range in order to decide if the first target state has been attained. Such a sensor is for example a sensor that measures the position of an actuated device. In case the actuated device has attained a pre-defined position within an acceptable margin, the second control unit assumes that the first target state has been attained.

The first control unit is for example a machine or process controller which controls the course of actions of actuating devices and process parameters, such as temperature, pressure, and speed. As an example for a machine controlled by the inventive method the following description will refer to a wind turbine. A wind turbine may comprise several control circuits, for example a wind turbine controller which controls the power generated by a generator propelled by the rotor of a wind turbine, a pitch system of a wind turbine for pivoting the rotor blades of a wind turbine, and a yaw system of a wind turbine for rotating the nacelle of wind turbine around the vertical axis of a wind turbine in order to ensure that the turbine is constantly facing into the wind to maximize the effective rotor area. The first control unit may also be a subsystem of the wind turbine, such as the pitch system controller or the yaw system controller. The first controller may also be a subsystem of a subsystem, such as the pitch drive controller of a pitch system for a wind turbine. The second control unit is an additional control unit for monitoring the first control unit.

In this aspect of the invention the second states can be chosen such that they correspond to well defined and tested states. For example a state “commanded movement” of a wind turbine could define such a well-defined state where the rotor is turning propelled by the force of the wind and controlled by the angle of the blades. Thus an operator would never consider to allow a person to work in the nacelle or in the area of the turning rotor blades. In a well-defined state the wind turbine can still harm a person if the person disregards general safety rules, such that a person is only allowed to work in a hazardous area when a motor brake is invoked, and the rotor blades are in a so-called feather position. These conditions may only be ensured in one specific second state, which is called herein “no movement”. As the second control unit only allows a few well defined and tested transitions from one second state to another second state this also avoids that the machine is operated in a way that has not been fully tested or which never has been considered by the wind turbine designer as a valid option to operate the wind turbine.

This aspect of the invention proposes the second control unit to be put in charge of controlling the first control unit. By means of the second control unit it is possible to upgrade a wind turbine to a higher safety level, whilst keeping the existing first control units, which do not comply with increased safety regulations, instead of replacing the existing control units by completely newly designed control units.

In terms of functional safety the first control unit may fulfil only the requirements of a safety level that is lower than the safety level provided by the second control unit. By using the second control of a higher safety level for controlling the first state of the first control unit and the transition between selected state of the first control unit the over-all risk originating from the wind turbine is reduced.

The feature of transmitting as a first input condition a command to the first control unit which initiates the first control unit to transition to the first target state when the received second input condition is a transition from the current second state to the second target state that is included in the set of pre-defined transitions includes allowing the first control unit to transparently receive all commands. In an alternative aspect of the invention, the second control unit is permanently invoking a blocking signal to the first control unit, which inhibits the first control unit from executing the transparently received first commands. When the second control unit detects an allowed transition it will lift the blocking signal for the required time of the transition.

In another aspect of the invention the method may further comprise the steps of in case the first control unit does not transition to the target state, resetting the first control unit.

In another aspect of the invention the method may further comprise the steps of additionally or alternatively in case the first control unit does not transition to the target state, initiating a transition to a specific state in which the wind turbine is in a safe operational state.

In another aspect of the invention the second control unit offers at least a first set of second states and a second set of second states which differ from each other. This aspect of the invention could be used to restrict access rights to view and/or control the first set of second states to a first group of users and to restrict access rights to view and/or control the second set of second states to a second group of users respectively. Alternatively the two sets may be used to switch the view between the first set of second states and the second set of second states. This allows to switch between different levels of abstraction and allow only certain actions in certain levels of abstraction.

In another aspect of the invention one or more of the at least two different sets of states could be used to define one set of states as a subordinate set of states to at least one of a superordinate state. In this case a state of the second control unit comprises at least two sub states. The second control unit analyses at least one of received commands, received sensor data, or received process data in an superordinate state and as a function of the analyses choses one of the sub states as a current sub state. This has the advantage that the sub states must not have exist before in the first control unit. They are introduced to the system by the second control unit.

In this aspect of the invention the second controller modifies or overwrites respectively the commands send to the first controller according to a pre-defined set of actions set up for each sub state.

An application of the sub states is a defined reaction to errors. The at least two sub states represent at least one error free sub state of the machine or process and at least one error status of the machine or process. In connection with a first controller that is not provided with error handling or only rudimentary error handling the second controller can use the sub states to introduce new reactions to new defined error situations. A sub state represents in this case a new error situation.

In another aspect of the invention the first control unit controls at least a third control unit, the at least at least third control unit having a third number of third states and being in a current third state which is one of the number of third states, the at least third control unit adapted as a function of a third input condition to transition from the current third state a another third state of the number of third states and at least a fourth control unit for controlling the at least third control unit, the fourth control unit having a fourth number of fourth states and being in a current fourth state, the fourth control unit adapted as a function of a fourth input condition to transition from one state of the number of fourth states to another state of the number of fourth states. The number of the fourth states of the fourth control unit may be lower than the number of the third states of the at least third control unit. The method further comprises mapping to each fourth state of the fourth control unit a third target state that is a state of the number of third states of the at least third control unit; pre-defining a set of transitions between the fourth states of the fourth control unit; receiving a fourth input condition as a fourth target state to which the fourth control unit shall transition from the current fourth state; checking if a transition from the current fourth state to the fourth target state is included in the set of pre-defined transitions; in the event the received fourth input condition is a transition from the current fourth state to the fourth target state that is included in the set of pre-defined transitions, performing as response to a third input condition a predefined set of actions which initiates the at least third control unit to transition to the third target state; supervising the at least third control unit if it transits to the third target state; in case the at least third control unit transited to the target state changing the current fourth state to the fourth target state.

In this embodiment the third control unit is a sub-control unit to the first control unit. For example in case the first control unit is a wind turbine controller, the third control unit may be a pitch system controller, or a yaw control system. The third control unit may also be a sub-system of a subsystem of a wind turbine, for example the pitch drive controller. In this latter case the first control unit would be the pitch system controller. The third control unit may comprise several third control units in parallel. For example in a wind turbine with three rotor blades there would be a single first control unit as the pitch system controller, controlling three third control units, each of the three third control units controlling the pitch angle of one of the three rotor blades.

In this aspect of the invention the fourth states can be chosen such that they correspond to well defined and tested states of the sub-system. In this aspect of the invention a fourth control unit is put in charge of controlling a third control unit. Again by means of fourth control units it is possible to upgrade a wind turbine to a higher safety level, whilst keeping the existing third control units, which do not comply with increased safety regulations, instead of replacing the existing control units by completely newly designed control units for a sub-system.

In this aspect of the invention the fourth control units from a hierarchical point of view take the role of a slave unit in respect to the second control unit and a master role in respect to an attributed third control unit.

In another aspect of the invention each second state of the number of second states corresponds with a fourth state of the number of fourth states.

This aspect of the invention may improve further the safety of the system as master control unit and slave control units use identical fourth and second states. This reduces the number of options and thus possible errors in the design rules.

The master control unit, i.e. the second control unit may additionally have the task to supervise that after a transition to another second state has been commanded, all slave units, i.e. all fourth control units have transited to the commanded fourth state, or if mast control unit and slave control unit use the same set of states, to the second state, before the master control unit will transition to the commanded state. By this it is ensured that all subsystems of a system are always corresponding second and fourth states, or in the same second state if identical second and fourth states are used. If one slave unit fails to transition into the commanded state, then the master control unit has to command itself and all slave control units in a second state, for example an autonomous movement, after which further actions, such as requesting service personnel, can be taken in order to get the defective part of a wind turbine repaired. This autonomous movement, for example, puts the rotor blades of a wind turbine in feathering position in order to shut down the wind turbine. So even if the wind speed increases, the rotor will not turn.

In another aspect of the invention the first control unit may transmit a second command to the at least third control unit as a third input condition.

In another aspect of the invention the second control unit supervises that all of the at least third control units are attaining the corresponding fourth target state in response to a first input condition.

In another aspect of the invention the second control unit when at least one of the at least fourth control unit is not attaining the corresponding fourth target state is resetting the at least one of the at least fourth control unit that is not attaining the corresponding fourth target state.

In another aspect of the invention the second control unit when at least one of the at least fourth control unit is not attaining the corresponding fourth target state is initiating a transition to a specific state in which the wind turbine is in a safe operational state.

In another aspect of the invention the second control unit and/or the at least fourth control unit are designed such that they comply with the design rules of a safety integrity level that is higher than the safety integrity level of the first and/or the at least third control units.

In another aspect of the invention he first and the at least third control unit communicate via a first communication path and the second and the at least fourth control unit communicate via a second communication path and wherein the second communication path is designed such that it complies with the design rules of a safety integrity level that is higher than the safety integrity level of the first communication path.

In another aspect of the invention the first and the second communication path are using the same communication medium and that the first communication path is using a first transmission protocol and the second communication path is using a second communication protocol and that the second communication protocol is a protocol with a higher safety integrity level than the first communication protocol.

In another aspect of the invention the first control unit and the second control unit are a pitch control system controlling the pitch angle of a at least one rotor blade of a wind turbine.

In another aspect of the invention the third control unit and the fourth control unit are pitch drive units for controlling the motor of a wind turbine that turns a rotor blades of a wind turbine.

In another aspect of the invention the wind turbine comprises a second control unit, wherein the second control unit comprises a processing device which is adapted to carry out the method steps of any of the preceding method steps.

### BRIEF DESCRIPTION OF THE DRAWINGS

A full and enabling disclosure of the present invention is set forth in the specification, which makes reference to the appended figures in which:

FIG. 1 shows a wind turbine;

FIG. 2 shows a conventional control system for a wind turbine;

FIG. 3 shows a conventional pitch system controller for a wind turbine;

FIG. 4 shows a conventional pitch drive unit for a wind turbine;

FIG. 5 shows control system for a wind turbine according to the invention;

FIG. 6 shows the states of a conventional pitch system controller;

FIG. 7 shows the states of a conventional pitch drive controller;

FIG. 8 shows the generic states of a pitch system according to the invention;

FIG. 9 shows a table with generic states of the pitch system according to the invention and corresponding target states of the conventional pitch system control module and the conventional pitch drive unit;

FIG. 10 shows a pitch system controller according to the invention;

FIG. 11 shows a pitch drive controller according to the invention;

FIG. 12 shows method steps performed by a controller in general for monitoring the transition from a current state to a target state based on a command.

FIG. 13 shows method steps performed by a controller based on receiving an event.

FIG. 14 shows method steps performed by a pitch system control module according to the invention in a wind turbine for monitoring the transition from generic NO MOVEMENT state S1 to generic COMMANDED MOVEMENT state S2.

FIG. 15 shows method steps performed by a pitch drive controller according to the invention in a wind turbine for monitoring the transition from generic NO MOVEMENT state S1 to generic COMMANDED MOVEMENT state S2.

FIG. 16 shows method steps performed by a pitch system controller according to the invention in a wind turbine for monitoring the transition from generic COMMANDED MOVEMENT state S2 via intermediate generic state

AUTONOMOUS MOVEMENT state S4 to generic NO MOVEMENT state S1.

FIG. 17 shows the transitions allowed for the generic sub states of the generic state NO_MOVEMENT

FIG. 18 shows sub states of the NO MOVEMENT state S1.

FIG. 19 shows different error modes of a pitch drive in the AUTONOMOUS MOVEMENT state S4.

FIG. 20 shows valid transitions from different error sub states.

### DETAILED DESCRIPTION OF THE INVENTION

Reference will now be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations that come within the scope of the appended claims and their equivalents.

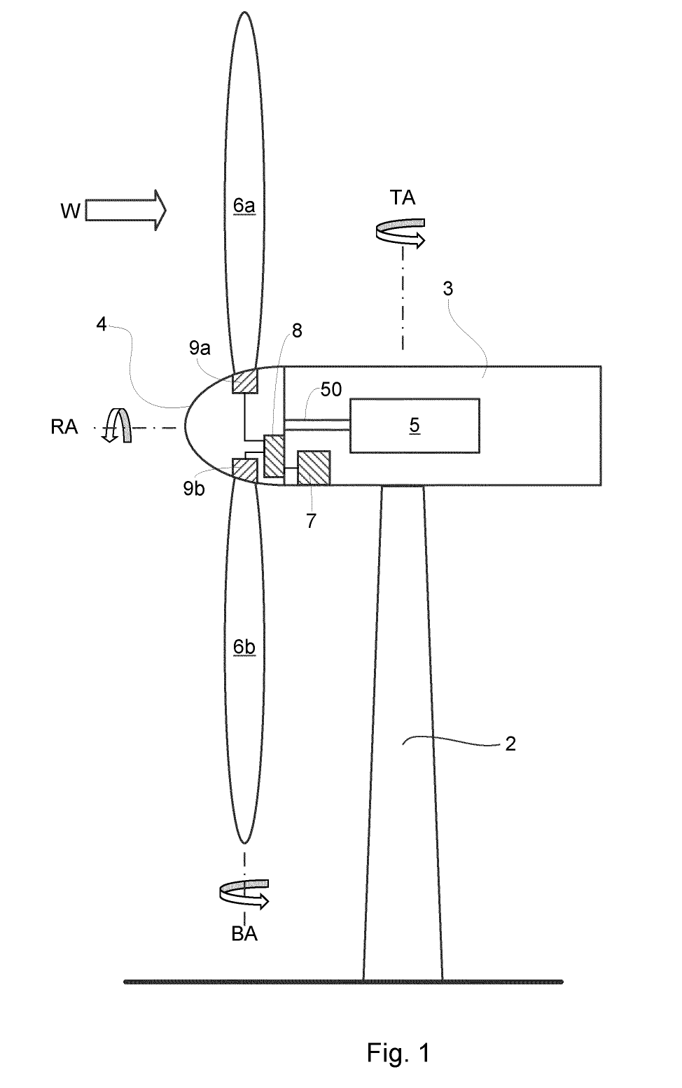

FIG. 1 shows an embodiment of a wind turbine 1 according to the invention from a side view. The wind turbine 1 with pitch control comprises several components. A tower 2 which supports the other component of the wind turbine is fixed to the ground. Of course, the invention is not limited to on-shore installations but could also be used in connection with so-called off-shore installations where the tower is fixed to a structure in the sea. On top of the tower 2 a nacelle 3 is rotatable mounted such that the nacelle 3 rotates around the axis TA of the tower 2. The nacelle 3 comprises a hub 4 and at least one rotor blade 6a which is rotatable fixed to the hub 4 The wind turbine depicted in FIG. 1 comprises three rotor blades 6a, 6b whereby only two rotor blades 6a, 6b are visible. The third rotor blade is not visible as it happens to be concealed by the hub. Hub 4 and rotor blades 6a, 6b, 6c are referred to also as the rotor of the wind turbine.

Each rotor blade 6a, 6b is mounted to a pitch drive unit 9a, 9b. As the wind turbine 1 in this example has three rotor blades 6a, 6b, there are three pitch drive units 9a, 9b, 9c (not shown in FIG. 1), one for each rotor blade 6a, 6b. The three pitch drive units 9a, 9b, 9c are controlled by a pitch system controller 8. Each pitch drive unit 9a, 9b, 9c turns each rotor blade 6a, 6b around a rotor blade axis BA. By turning the rotor blades 6a, 6b around their axis BA the angle of attack of the rotor blades 6a, 6b to the wind W can be set to an angle between 0° and 90°, in some installations even negative angles or angles greater than 90° are known. The angle of attack may be chosen thus that the blades 6a, 6b produce no lift, produce maximum lift, or any desired lift in between these two extremes in response to a wind force W.

In FIG. 1 the nacelle 3 is pivoted around its axis TA such that the rotor 4 is facing wind W. In case the rotor blades 6a, 6b are pitched such that the wind W generates lift on the rotor blades 6a, 6b, the lift will force the rotor 4 to spin around a rotor axis RA. An electric current generator 5 coupled by a generator shaft 50 to the rotor 4 produces electric energy which may be fed into an energy distributing net (not shown). The pitch angle of the rotor blades 6a, 6b eventually controls the rotation speed of the rotor 4 and thus also the amount of produced energy.

In one aspect of a wind turbine the pitch system controller 8 and the three pitch drive units 9a, 9b, 9c constitute a pitch control sub system 8, 9a, 9b, 9c which controls the pitch angle of the rotor blades 6a, 6b independently from other sub systems of the wind turbine 1. A wind turbine may consist of several sub systems, for example another subsystem (not shown) for controlling the rotation of the nacelle 3 around the vertical axis TA and another subsystem comprising the current generator 5 for generating electric power. Each sub system may be supplied by a different manufacturer, respectively subcontractor and may be centrally controlled by the wind turbine control unit 7.

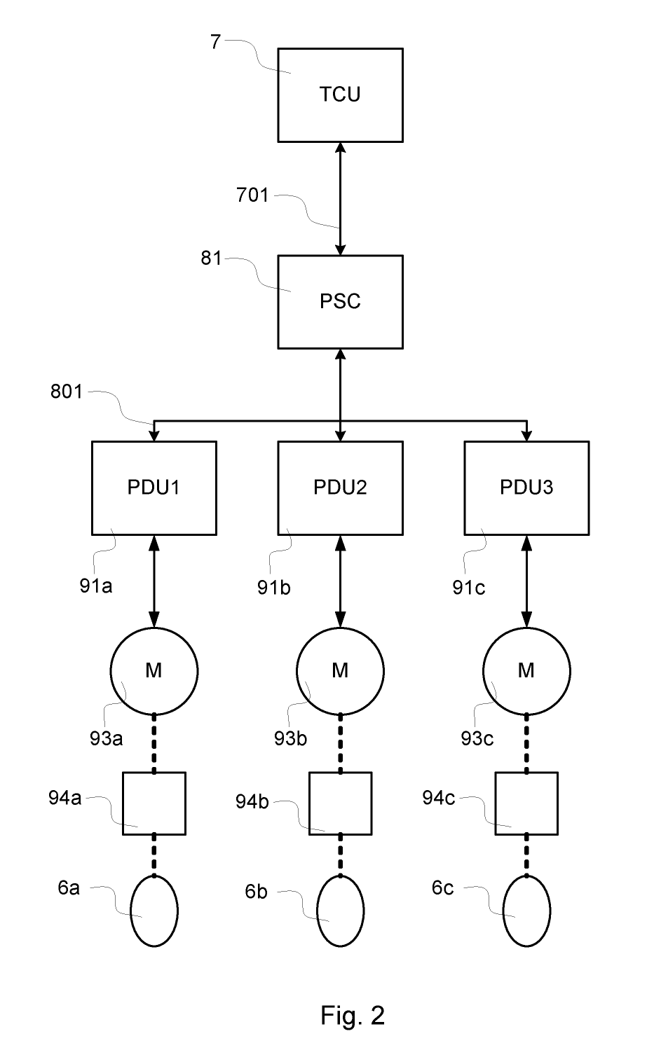

FIG. 2 shows as a functional overview a pitch control system 81, 91a, 91b, 91c of a prior art wind turbine 1 interacting witch the wind turbine control unit 7. The wind turbine control unit 7 controls via a first data connection 71 a conventional pitch system control module 81. This first data connection 701 is for example a conventional field bus. The conventional pitch system control module 81 in turn controls via a second data connection 801 three conventional pitch drive control module 91. This second data connection 801 is for example another conventional field bus. The field buses may for example also be a single field bus that is used in common by all control equipment. Each pitch drive control module 91a, 91b, 91c eventually controls a motor 93a, 93b, 93c. Each motor is coupled, for example via gears 94a, 94b, 94c to the first, second, and third rotor blade 6a, 6b, 6c. The motors turn (pitch) the rotor blades to a desired angle. The adjective “conventional” shall indicate that the conventional pitch system control module 81 and the three conventional pitch drive control module 91 may be known from prior art, or do not provide for an enhanced safety level, respectively.

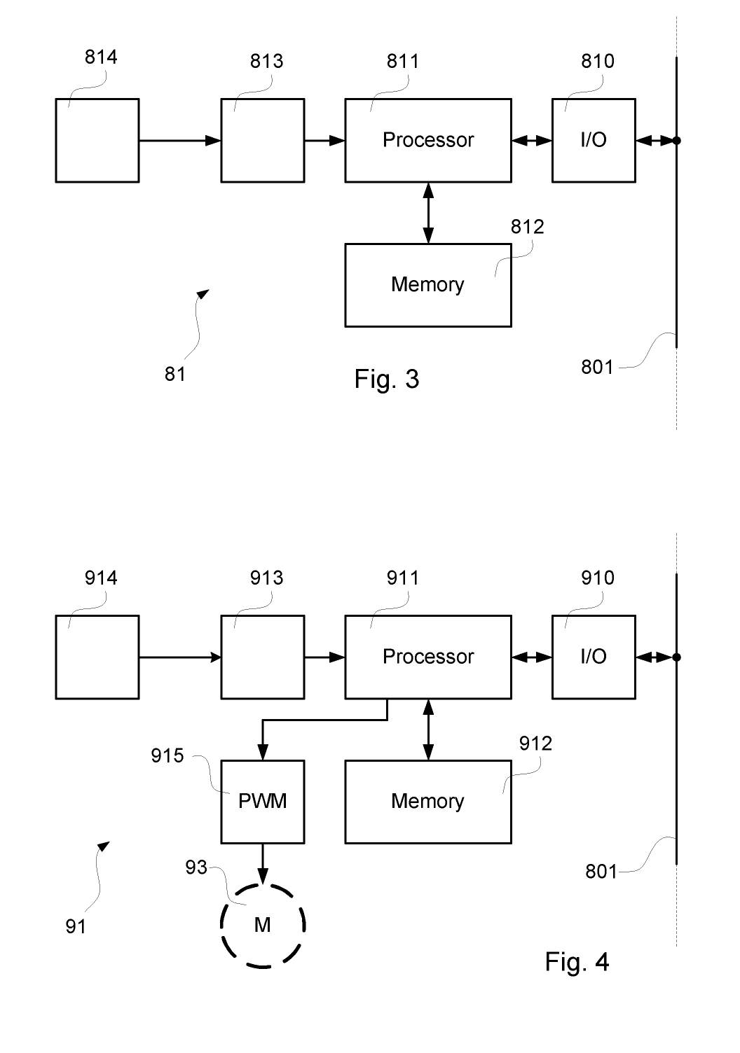

FIG. 3 shows illustrated as a block diagram an embodiment of a conventional pitch system control module 81 and components it may comprise. The conventional pitch system control module 81 may comprise one or more processors 811 and associated memory devices 812 configured to perform a variety of computer-implemented functions such as performing the method steps, calculations and the like and storing relevant data as disclosed herein. The conventional pitch system control module 81 may be implemented as one or more printed card boards which are plugged into a pitch system controller card board carrier back plane (not shown). For communicating with various sensors 814, a sensor interface 813 permits signals transmitted from sensors 814 to be converted into signals that can be understood and processed by the processor 811. The sensors 814 may be coupled to the sensor interface 813 via a wired connection, which for example are electrically connected to the said pitch system controller card board carrier back plane. In other embodiments they may be coupled to the sensor interface via a wireless connection.

The conventional pitch system control module 81 also comprises a conventional field bus interface 810 for communicating on the conventional field bus 801 with the conventional pitch drive control module 91. Via the conventional field bus 801 further sensor data or other data from other parts of the wind turbine 1 can be received. Via this conventional field bus 801, the conventional pitch system control module 81 may be able to read the power that is generated by the electric generator in the nacelle 3. In this embodiment, the conventional field bus 801 is also used to send and receive commands and data from three conventional pitch drive control module 91 which individually control the pitch angle of each rotor blade 6a, 6b.

FIG. 4 shows illustrated as a block diagram one embodiment of components that may be included within the conventional pitch drive control module 91. The conventional pitch drive control module 91 comprises one or more processors 911 and associated memory devices 912 configured to perform a variety of computer-implemented functions such as performing the method steps, calculations and the like and storing relevant data as disclosed herein. The conventional pitch drive control module 91 may be implemented as one or more printed card boards which are plugged into a pitch drive unit card board carrier back plane (not shown). For communicating with various sensors 914, a sensor interface 913 permits signals transmitted from sensors 914 to be converted into signals that can be understood and processed by the processor 911. The sensors 914 may be coupled to the sensor interface 913 via a wired connection which for example are electrically connected to the said pitch drive unit card board carrier back plane. In other embodiments they may be coupled to the sensor interface via a wireless connection.

The conventional pitch drive control module 91 also comprises a conventional field bus interface 910 for communicating on the conventional field bus 801 with the conventional pitch system control module 81. Via the conventional field bus 801 further sensor data or other data from other parts of the wind turbine 1 can be received. The processor 911 of the conventional pitch drive control module 91 is connected to a pulse width modulator circuit 915 to control the rotation of the electro mechanical motor 93 for rotating the rotor blades 6a, 6b around their axis BA.

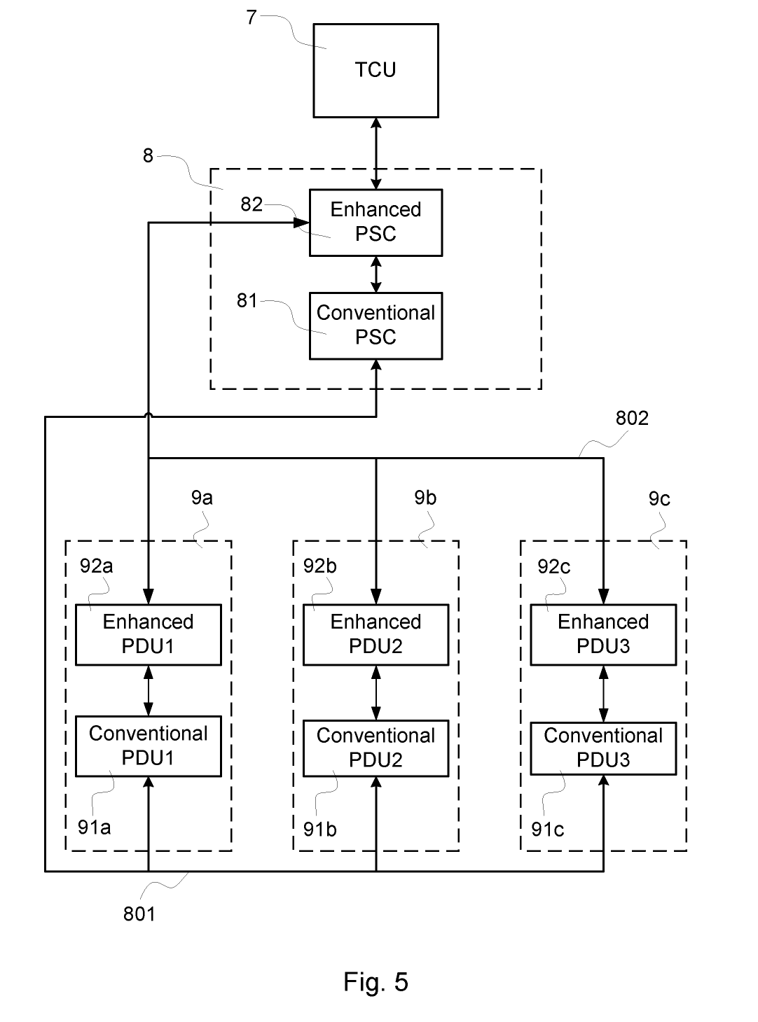

FIG. 5 shows as a functional overview the control system of a wind turbine 1 according to an aspect of the invention. The wind turbine control unit 7 controls a pitch system controller 8 and other control units, which are not shown. The pitch system controller 8 comprises a first pitch system control module 81, for example a conventional pitch system control module 81 as described above, and a second pitch system control module 82 for monitoring, respectively controlling the first pitch system control module 81 via a fourth data connection 84. As the invention is not only applicable to conventional pitch system controller and conventional pitch drive controller, the pitch system controller that is monitored by the second pitch system control module 82 will be termed in the following more general as first pitch system control module 81.

The fourth data connection is for example used to forward commands received by the second system control module 82 from the wind turbine control unit 7 to the first pitch system control module 81. The pitch system controller 8 controls three pitch drive units 9a, 9b, 9c. Each pitch drive unit 9a, 9b, 9c comprises a first pitch drive control module 91 and a second pitch drive controller 92. Each first pitch drive control module 91 may be a commonly known pitch drive controller, for example a conventional pitch drive unit as described above. As the invention is also applicable to non-conventional pitch drive units the pitch drive controller which is monitored by the second pitch drive module 92 will be termed in the following as first pitch drive control module 91.

The second pitch system control module 82 and the three second pitch drive control module 91 may be used to transform a conventional system as shown for example in FIG. 2 or any system with no or a low safety integrity level into a system with a higher safety level by adding a second control layer for the first pitch system control module 81 and the three first pitch drive control module 91. According to its purpose the second control layer is termed in this document “safety control layer”.

The safety control layer is implemented for example as plug-in boards that are plugged in the same card board back planes into which also the first pitch system control module 81 and the first pitch drive control module 91 are plugged in. The logical functions may be controlled by software. In this example the second pitch system control module 82 controls the first pitch system control module 81. Each of the three second pitch drive control modules 92a, 92b, 92c controls one the three first pitch drive control module 91. The first pitch system control module 82 and the three second pitch drive control modules 92 are each running on second processor systems developed according IEC 61508 and systematic capability greater safety integrity level SIL1.They are communicatively connected via the second field bus 802 which also fulfils IEC 61508 and systematic capability greater safety integrity level SIL1. IEC 61508 is the international standard for electrical, electronic and programmable electronic safety related systems which sets out the requirements for ensuring that systems are designed, implemented, operated and maintained to provide a required safety integrity level (SIL).

In this embodiment, the first pitch system control module 81, the second pitch system control module 82, the first pitch drive control modules 91a, 91b, 91c, and the second pitch drive control modules 92a, 92b, 92c are physically distributed over different locations. The number of first pitch drive control modules 91a, 91b, 91c and the number of second pitch drive control modules 92a, 92b, 92c corresponds to the number of rotor blades in a wind turbine 1. Usually they are constructed identically. In the following, in order to improve intelligibility, we refer to first control modules 91, which could be any number of pitch drive control modules 91a, 91b, 91c including even a single pitch drive control module in case of a wind turbine with only a single rotor blade. The person skilled in the art will appreciate that the first pitch system control module 81 and the first pitch drive control modules 91 may be distributed over more locations, mounted in several control boxes or may be centralised in a single location, in a single control box, using only a single processor. This is a matter of the most convenient design in an individual case and does not change the scope of the invention.

The first pitch system control module 81 and the first pitch drive control modules 91 communicate via the first field bus 801. The pitch system control module 82 communicates with the second pitch drive control modules 92 via a second field bus 802, which according to its function is termed within this document as safety field bus 802. Although the first field bus 801 and the safety fieldbus 802 are described as two separate field buses they may share the same physical medium. The safety field bus 802 may be implemented by using an enhanced protocol that ensures a higher safety level than the first field bus 801.

The use of a safety fieldbus in connection with safety fieldbus interfaces of the second pitch drive control modules 92 eliminates the need of a hardware safety chain, such as a dedicated wired line from the wind turbine control unit 7 to the first pitch system control module 81 and/or the first drive units 9a, 9b, 9c for triggering an emergency stop. Thus a higher safety level can be achieved without the need of modifying or exchanging the turbine controller.

In one aspect of the invention both the first pitch system control module 81 and the second pitch system control module 82 are implemented as finite state machines. By common definition, a finite state machine is conceived as an abstract machine that can be in one of a finite number of states. The machine is in only one state at a time; the state it is in at any given time is called the current state. It can change from one state to another when initiated by a triggering event or condition; this is called a transition. A particular finite state machine is defined by a list of its states, and the triggering condition for each transition. Hereby a state is a description of the status of a system that is waiting to execute a transition. A transition is a set of actions to be executed when a condition is fulfilled or when an event is received, such as the reception of a command.

Ideally, if a conventional controller, i.e. the first pitch system controller 81 and the first pitch drive module 91 were designed in the first place as a finite state machine the conventional controller will provide defined states. However, the advantage of the invention is that the conventional controller must not have been originally designed with intentionally defined states. Alternatively, or in addition to existing states of the conventional controller, states may be especially defined only for the use by the enhanced controller. States of the conventional controller can be chosen from any properties of the conventional decoder such as switching status, e.g. no power supply or control signals for motor are blocked, or measurement results of sensors, such as angle of rotor blade between 1° and −1°, temperature of emergency storage below −20° C., motor current above 100 A, which are under the control of the conventional encoder. A state may be defined also by a combination of a plurality of such properties.

In contrast hereto the states of the enhanced controller are defined explicitly for the purpose of supervising the conventional controller. In addition they may take into account sensor readings for a plausibility check that the status reported from the conventional decoder can be trusted. This readings may originate from an additional installed sensor, accessible for the enhanced controller only, or an existing sensor of the conventional controller that was not used for this purpose by the conventional controller.

In case the conventional controller have been designed not strictly as a finite state machine it may be difficult to control the allowed transitions. In contrast to the various state of the first pitch system control module 81 the finite state machine of the second pitch system control module 82, allows only a few, pre-selected state which are compliant to improved safety regulations, as the aforementioned standard IEC 61508. In prior art wind turbines the operator may have been able to command the wind turbine to transition to a state which may have not been recommended. Under improved safety conditions the operator should not be given the opportunity to change the machine from a specific state to another state, as this transition might cause the machine to operate differently than what the operator would expect the machine to work. The operator might not be aware of the consequences, as he would have to read carefully the instruction manual, which as a fact; some machine operators have a tendency to ignore. Or the consequences may not even be documented, as the designer of the wind turbine never expected an operator to operate the machine in this way. For example from analysing the operation of a wind turbine it may have been found that it is not advisable to allow an operator to switch directly from “manual movement” to “commanded movement” during servicing the wind turbine. Other risky operation situations may have been already forbidden in the prior art systems and such do not need to be supervised. Such a forbidden operating situation, that is already considered by the prior art system could be to prohibit to operate an electric circuit when the temperature of the electric circuit is still below the design operation temperature as this may for example cause data read from a memory to be erroneous.

Another object of the invention therefore is to limit the number of operations an operator can choose from and also limit the number of transitions from one second state to another second state, such that only a few, pre-designed second transitions are made accessible to the operator and other, theoretically possible transitions are blocked. The blocked transitions are blocked either because they definitely would harm the operation of the wind turbine or because the safeness of the transition has not been fully explored. For example the operation philosophy might want to force an operator who wants to change the wind turbine from “autonomous power operation” to “manual operation” to set the machine from autonomous operation first into a “no movement state” and only from there into the “manual movement state”.

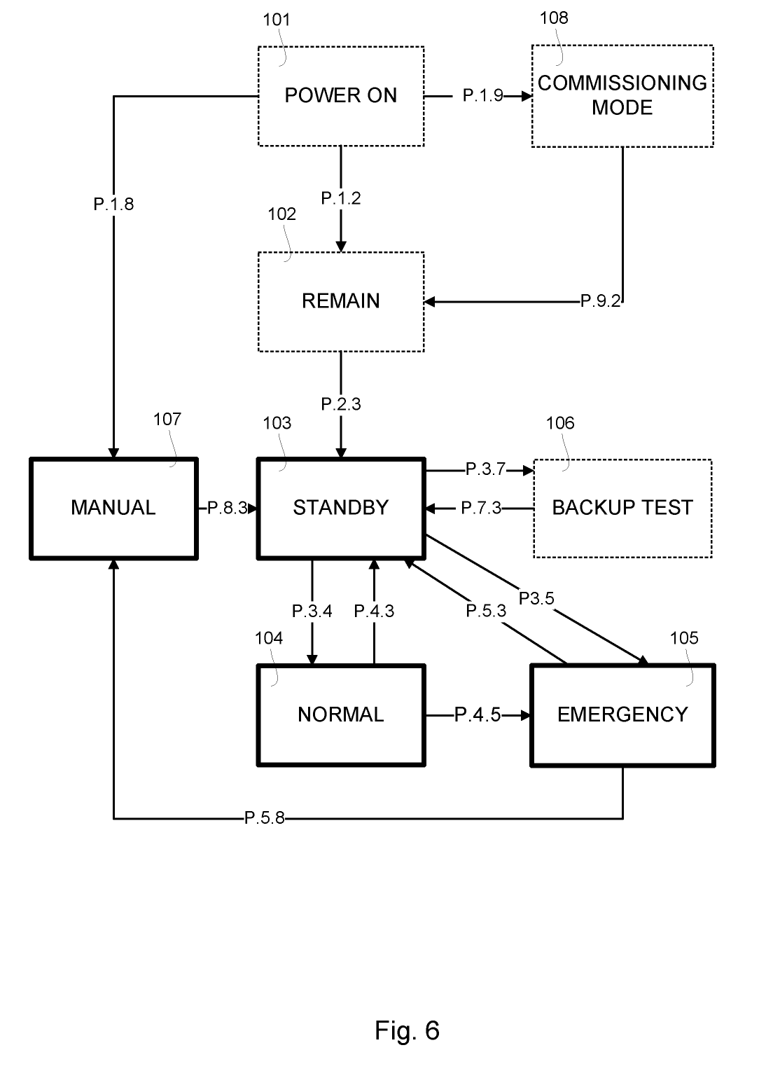

In the following all states of the first pitch system control module 81 and the three decentralized pitch drive control module 91, will be discussed to the extent that it is necessary to understand the implementation of the inventive safety control system. In this specific embodiment, the first pitch system control module 81 has exactly eight first pitch system states, as depicted in FIG. 6:
A first first pitch system state POWER ON 101;
a second first pitch system state REMAIN 102;
a third first pitch system state STANDBY 103;
a fourth first pitch system state NORMAL 104;
a fifth first pitch system state EMERGENCY 105;
a sixth first pitch system state BACK UP TEST 106;
a seventh first pitch system state MANUAL 107; and
an eighth first pitch system state COMMISSIONING MODE 108.

The person skilled in the art will appreciate that the first pitch control unit for a wind turbine 1 may possess even more pitch system states or even less pitch system states. The POWER ON state 101 is the initial state of the pitch drive control module 81 when the wind turbine is taken into operation and the wind turbine 1 is supplied with electric power. In this state the blades 6a, 6b usually would be in a feathering position, i.e. they are pitched such that wind facing the rotor 4 would not produce any lift preventing the blades 6a, 6b to turn under the force of the wind W.

In the REMAIN state 102 the system has to ensure that some basic conditions are met, before the pitch system control module 81 is allowed to proceed to another state. For example one or a plurality of temperature sensors measure the temperature in the one or plurality of control boxes. If the temperature in all of the boxes is in the defined range, the pitch system state would be changed into the third pitch system state STANDBY 103. In the event the temperature is below the defined temperature range heating elements will be activated to heat the interior of the control boxes until the defined temperature range is attained. The REMAIN state 102 therefore is part of the safety rules of the system that provide some basic system safety. In the STANDBY state 103 all preconditions are met to set the pitch system control module 81 into operation. However, for safety reasons the pitch motors 93a, 93b, 93c are still braked.

The fourth pitch system state NORMAL 104 is the state in which the pitch system control module enables the wind turbine 1 to run in normal operation and to generate power. It regulates the rotor speed so that a maximum of energy is produced but on the other hand the design loads are not exceeded.

In case of a power break down or any other severe failure the wind turbine will transition into the fifth pitch system state EMERGENCY 105 in which basically the pitch control module 91 is commanded to turn the blades 6a, 6b into the feathering position. As part of the design rules that increase the safe operation the pitch system 8, 9 has to be able to go into the EMERGENY state 105 even when there is no power generated from the wind turbine generator 5 or available from the external sources, such as the power grid (not shown). Wind turbines therefore have an emergency power supply, which for electro-mechanic actuated pitch control systems may be a backup battery and for hydraulic operated pitch control systems may be a hydraulic accumulator. In the sixth pitch system state BACK UP TEST 106 this emergency power supply is tested if the capacity of the emergency power supply is sufficient to drive the wind turbine into the EMERGENCY state 105.

For test purposes for example, an operator may want to operate the wind turbine by means of a manual control box and thus needs to set the wind turbine in the seventh pitch system state, the MANUAL state 107. In the COMMISSIONING state 108 the control software can be updated to a new version.

The pitch system control module 82, once triggered in a certain state, will either switch to another state or run autonomously trough a number of pre-determined states until it has arrived at a certain state. So for example, after the wind turbine is powered on, the pitch system control module 81 will start in POWER ON state 101, will switch autonomously to REMAIN state 102, if the basic conditions are met, and then will enter and stay in STANDBY state 103. Triggered by a command it will switch from STANDBY state 103 to NORMAL state 104, MANUAL state 108 or, to EMERGENCY state 105.

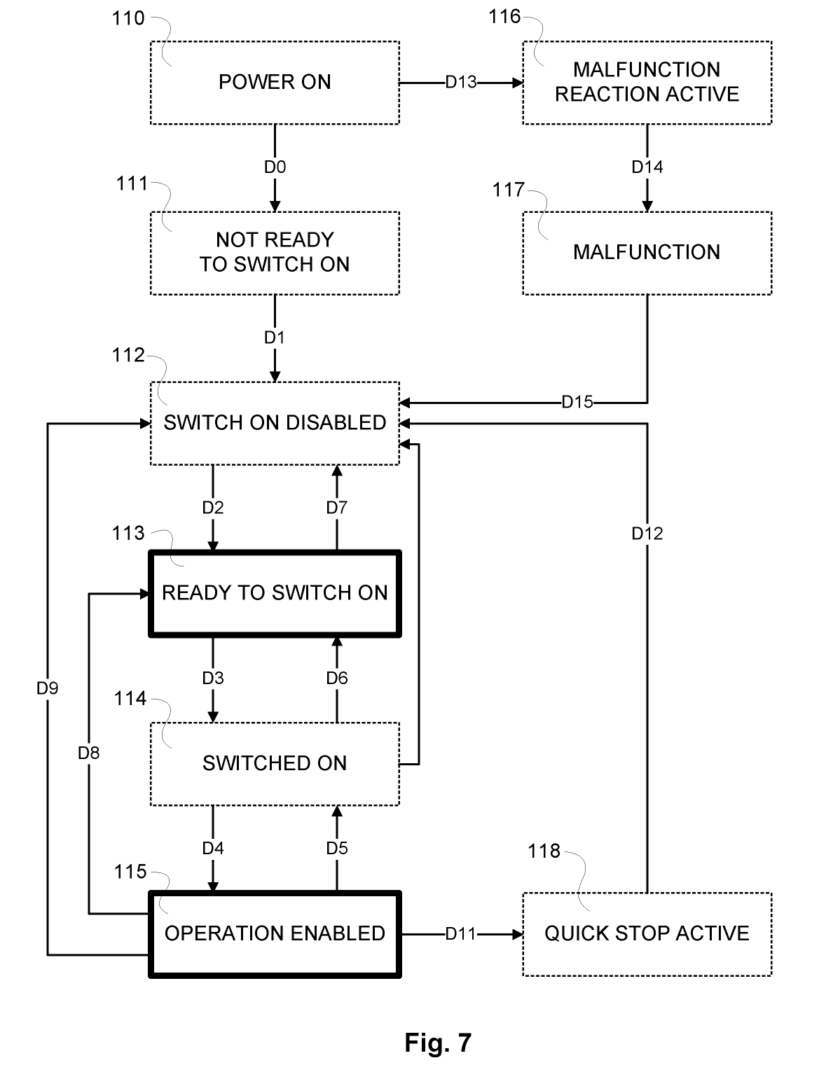

FIG. 6 also shows as arrows the transitions from one pitch system state to another pitch system state which are allowed in the pitch system control module 81. Already the internal system is designed to allow only a few pre-determined transitions between specific states of the pitch system control module 81. So, for example, there is a transition P.4.5 from the NORMAL state 104 to the EMERGENCY state 105 but no transition from the EMERGENCY state 105 back to the NORMAL state 104. As a matter of precaution the system would only allow a transition P.5.3 from the EMERGENCY state 105 to the STANDBY state 103 or a transition P.5.8 to the MANUAL state 108.

Whereas the pitch system control module 81 basically determines the pitch angle that each rotor blade 6a, 6b should take, the pitch drive control module 91 will control electromechanical actuators 93a, 93b, 93c to steer the pitch angle of the specific rotor blade 6a, 6b to the angle commanded by the pitch system control module 81. As depicted in FIG. 7 in one aspect of the invention the pitch drive control module 91 in the embodiment of the invention has nine pitch drive states and fifteen possible transitions between these eight pitch drive states of the first pitch drive control module 91. The nine pitch drive state of the first pitch drive control modules 91 are:

A first pitch drive state POWER ON 110,
a second pitch drive state NOT READY TO SWITCH ON 111;
a third pitch drive state SWITCH ON DISABLED 112;
a fourth pitch drive state READY TO SWITCH ON 113;
a fifth pitch drive state SWITCHED ON 114;
a sixth pitch drive state OPERATION ENABLED 115;
a seventh pitch drive state MALFUNCTION REACTION ACTIVE 116
an eight pitch drive state MALFUNCTION 117; and
a ninth pitch drive state QUICK STOP ACTIVE 118.

In this aspect of first pitch drive units 9 according to the invention each first pitch drive control module 91 is controlled by the first pitch system control module 81 by only two commands: ENABLE CONTROL and FAULT RESET. Normally the first pitch system control module 81 sets the drive via ENABLE CONTROL from READY TO SWITCH ON state 113 to OPERATION ENABLED state 115 and back by clearing the command. Whilst a reference value from the wind turbine control unit 7 via the pitch system controller 8 to set the angle of attack of a rotor blade 6a, 6b may be transmitted to the pitch drive units 9a, 9b, 9c at any time, the first pitch drive control module 91 will accept a position reference value only in OPERATION ENABLED state.

The command FAULT RESET is used to leave the MALFUNCTION state 117. SWITCH ON DISABLED state 112 is reached by losing power supply (grid and backup) or critical faults like the system having overtravelled a first limit switch. All others states POWER ON state 110, NOT READY TO SWITCH ON state 111, SWITCHED ON state 114, MALFUNCTION, REACTION ACTIVE state 116, and QUICK STOP ACTIVE state 118 are transient states. These transient states are influenced by external events (e.g. no voltage to the drive, second limit switch reached). The transitions between the pitch drive states are explained in more detail in the following:

After the power of the pitch drive units 9 is switched on the first drive control module 91 is in POWER ON state 110 and executes a basic self-test. If the basic self-test has been passed successful, the first pitch drive control module 91 will transition in a transition DO to the NOT READY TO SWITCH ON state 111. In the event of a failed self-test the first pitch drive control module 91 will transition in a transition D13 to the MALFUNCTION REACTION ACTIVE state 116. It should be mentioned that if a malfunction occurs in one of the a second pitch drive state NOT READY TO SWITCH ON 111, the third pitch drive state SWITCH ON DISABLED 112, the fourth pitch drive state READY TO SWITCH ON 113, the fifth pitch drive state SWITCHED ON 114, the sixth pitch drive state OPERATION ENABLED 115, or the ninth pitch drive state QUICK STOP ACTIVE 118 there is a transition from this specific state to the MALFUNCTION REACTION ACTIVE state 116. In order to keep the drawing more legible in addition to the transition D13 from the POWER ON state 110 to the MALFUNCTION REACTION ACTIVE state 116 in the event of a malfunction only the transition D16 from NOT READY TO SWITCH ON 111 to MALFUNCTION REACTION ACTIVE state 116 is depicted in FIG. 7.

In state NOT READY TO SWITCH ON 111 some conditions for operating the drive are missing (e.g. DC link voltage). The motor is torque free and braked. This state is the default state when the power supply for the first pitch unit is switched on. The only transition D1 allowed from the first pitch drive state NOT READY TO SWITCH ON 111 is apart from the case of a malfunction the transition to SWITCH ON DISABLED 112.

In state SWITCH ON DISABLED 112 it is forbidden to switch on active control of the motor by some special commands (e.g. digital Input “Enable Power”). The motor is torque free and braked. The only transition D2 allowed from the SWITCH ON DISABLED state 112 is to the READY TO SWITCH ON state 113.

In the READY TO SWITCH ON state 113 the drive is waiting for a switch on command. The motor is torque free and braked. The only transition D3 allowed from the READY TO SWITCH ON state 113 is to SWITCHED ON state 112.

In SWITCHED ON state 112 the motor is powered on but the reference values are still blocked. The brake is opened after a predefined time so that the motor can be controlled in standstill. In the event all preconditions, such as applying torque to the motor are met to proceed to the subsequent state, the first pitch drive control module 91 will transition in transition D4 to the OPERATION ENABLED state 113. In the event at least one the preconditions to proceed to the OPERATION ENABLED state 113 are not met, the first pitch drive control module 91 will transition in transition D16 back to the SWITCH ON DISABLED state 112.

In OPERATION ENABLED state 113 the motor is powered on, brake is open and the motor follows the reference commands. A transition from OPERATION ENABLED state 113 is only envisaged in case of an intentional shutting down of the pitch drive or in the event of an error. In the event of an intentional shut down the first pitch drive control module 91 will transition in transition D8 back to the READY TO SWITCH ON state 113. By clearing the “switch on” command the first pitch drive control module 91 will transition in transition D9 to SWITCH ON DISABLED state 112. By a special “quick stop” command all first pitch drive control module 91 will transition in transition D11 to QUICK STOP ACTIVE state 118.

In MALFUNCTION REACTION ACTIVE state 116 the drive follows some fault reaction, e.g. ramping down to standstill. The erroneous first pitch drive control module 91 will then transition in transition D14 to the MALFUNCTION state 117. In the MALFUNCTION state 117 the drive is in an active error state. It signals error. The motor is torque free and braked. In the event the error is fixed first pitch drive control module 91 will then transition in transition D15 to SWITCH ON DISABLED state 112 in order to resume its operation.

In QUICK STOP ACTIVE state 118 the first pitch drive control module 91 decelerates at the quick stop ramp to standstill and disables the motor control. It stays in this state until the Quick Stop command is cleared and it transits in transition D12 to the SWITCH ON DISABLED state 112 in order to resume its operation.

Each first pitch drive control module 91a, 91b, 91c will be triggered by a command from the first pitch system control module 81 switch to another state, or run autonomously, as long as no error occurs to a target state. For example when the first pitch drive control module 91a is powered on, it will start in NOT READY TO SWITCH ON state 111, and run in that order through the SWITCH ON DISABLED state 112, the READY TO SWITCH ON state 113, the SWITCHED ON state 114 until it has attained the OPERATION ENABLED state 115. In case of an emergency situation, where it is necessary to go into the feathered position the first pitch drive unit will switch to QUICK STOP ACTIVE state 118 and will stay in this state until the quick stop command is cleared and it then will switch to SWITCH ON DISABLED state 112, and from there run autonomously through the SWITCH ON DISABLED state 112, READY TO SWITCH ON state 113, SWITCHED ON state 114 until it has attained again the OPERATION ENABLED state 115.

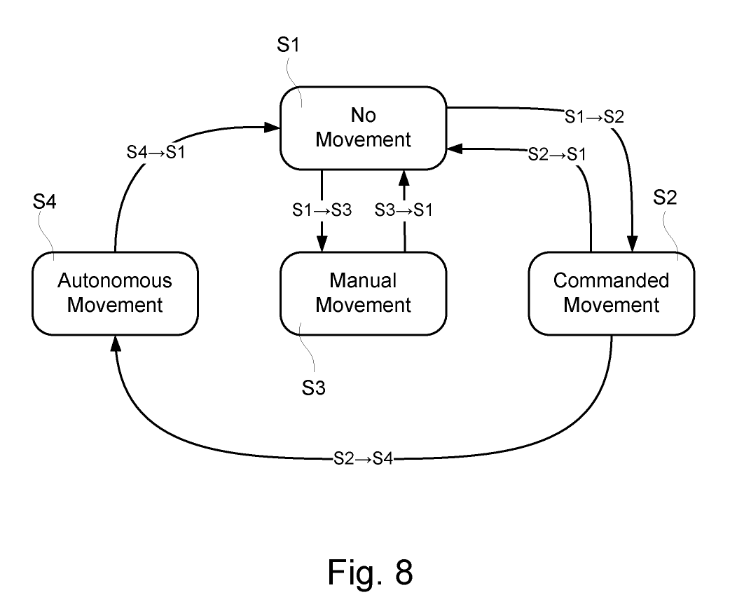

FIG. 8 shows as an aspect of the invention the restricted states of a safety pitch system control system 8, 9 which are accessible for the wind turbine control unit 7 and the limited transitions between the specific states. There are only four restricted states: NO MOVEMENT state S1, COMMANDED MOVEMENT state S2, MANUAL MOVEMENT state S3, and AUTONOMOUS MOVEMENT state S4. According to their function these states are termed in the following as the “generic” states S1, S2, S3, S4 as each generic state S1, S2, S3, S4 may comprise more than one corresponding state of the pitch system controller 81 or the pitch drive control unit 9. In NO MOVEMENT state S1 the pitch system controller 8 assures that the rotor 4 will not turn under any circumstances. In COMMANDED MOVEMENT state S2 the safety pitch system controller operates the pitch drives such that the wind turbine 1 is producing energy. In MANUAL MOVEMENT state S3 the pitch system controller 8 allows an operator to operate the wind turbine manually and in AUTONOMOUS MOVEMENT state S2 the wind turbine proceeds to the feathering position.

The safety pitch system controller 8 allows only six transitions between the generic states. A first transition S1→S2 from NO MOVEMENT state S1 to COMMANDED MOVEMENT state S2; a second transition S2→S1 back from COMMANDED MOVEMENT state S2 to NO MOVEMENT state S1; a third transition S2→S4 from COMMANDED MOVEMENT state S2 to AUTONOMOUS MOVEMENT state S4; a fourth transition S4→S1 from AUTONOMOUS MOVEMENT state S4 to NO MOVEMENT state S1; a fifth transition S1→S2 from NO MOVEMENT state S1 to MANUAL MOVEMENT state S3; and a sixth transition S3→S1 from MANUAL MOVEMENT state S1 back to NO MOVEMENT state S1.

In the following the operation of the pitch drive units 9 of a wind turbine 1 with the implementation of the second control layer. After the wind turbine 1 has been connected to an external power system and is taken into operation the operator will have to wait until the first pitch system control module 81 signals to the wind turbine control unit 7 that the first pitch drive control module 91 are ready to operate. Until this stage is achieved the generic state of the safety pitch system controller 8 is NO MOVEMENT S1.

In this aspect of the invention NO MOVEMENT state S1 corresponds to one of the states POWER ON 101, REMAIN 102, COMMISSIONING MODE 108, BACKUP TEST 106 or STANDBY 103 of the first pitch system control module 81. Similarly a first pitch drive control module 91 is in NO MOVEMENT state S1 only if it is in one of the states POWER ON 110, NOT READY TO SWITCH ON 111, SWITCHED ON DISABLED 112 or READY TO SWITCH ON 113. However, in regular operation each transition from an allowed generic state to another generic state completes in a target state. In FIGS. 6 and 7 the boxes representing target states are marked with continuous lines and the boxes representing transient states are marked by dashed lines. The target states will be explained in more detail further below,

The safety pitch system controller 8 signals the NO MOVEMENT state S1 to the wind turbine control unit 7. According to the design of the safety layer the wind turbine control unit 7 has only two options to proceed from the state NO MOVEMENT Si. Either the wind turbine control unit 7 commands to switch the safety pitch system controller 8 into COMMANDED MOVEMENT S2 or into MANUAL MOVEMENT S3. In the state NO MOVEMENT S1 the safety pitch system controller 8 will ignore any other command sent by the wind turbine control unit 7.

In the event, the wind turbine control unit 7 sends the command NORMAL OPERATION , the second pitch system control module 82 will execute the first transition S1→S2 in order to switch the wind turbine into COMMANDED MOVEMENT S2.

In one specific embodiment the operator chooses MANUAL MOVEMENT S3 by activating a manual control unit. The manual control unit for example can be connected to the second pitch system control module 82 by a wire which is plugged into a socket of the second pitch system control module 82. In this embodiment the connection of the manual control unit triggers an event MANUAL OPERATION which is reported to the second pitch system control module 82.

On detection of the event MANUAL OPERATION the pitch system controller 8 is set into MANUAL MOVEMENT state S3 by executing the fifth second transition S1→S3. In order to allow a transition of the first pitch system control module 81 from NORMAL state 104 to MANUAL state 107 the second pitch drive control module 92 firstly, as an intermediate state, has to urge the first pitch drive control module 91 into EMERGENCY state 105, to achieve a well-defined starting position for the MANUAL MOVEMENT S3. In EMERGENCY state 105 the pitch drive system 8, 9 is in feathering position and therefore the rotor is not turning, as the rotor blades 6a, 6b do not produce any lift. Therefore this state of the wind turbine generally is called a safe state of the wind turbine 1. This safe state of a wind turbine coincides with the first generic state NO MOVEMENT S1. From this safe state of the wind turbine 1 then the second pitch control module 82 allows the first pitch system control module 81 the transition to the MANUAL state 107.

In another embodiment the manual control unit may be connected to the wind turbine control unit 7. In such an embodiment the wind turbine control unit 7 could be configured to send on activation of the manual control unit a command MANUAL OPERATION to the pitch system controller 8 for urging the pitch system controller 8 to switch into MANUAL MOVEMENT S3 by executing the fifth second transition S1→S3 as described above.

The pitch system 8, 9a, 9b, 9c may be implemented at least in two different ways. One implementation could chose to provide a superordinate pitch system controller controlling the pitch system controller 8 and the three final states of the first pitch drive controller 9a, the second pitch drive controller 9b, and the third pitch drive controller 9c. In such an embodiment the finite state machine of the superordinate pitch system will only transition from a current state to a target state if all finite state machine the pitch system 8, the first pitch drive controller 9a, the second pitch drive controller 9b, and the third pitch drive controller 9c have attained their states that correspond to one of the safe pitch system states. However, in the first pitch control system 81, 91a, 91b, 91c the first pitch system controller 81 monitors the first pitch drive control module 91a of the first pitch drive unit 9a, the first pitch drive control module 91b of the second pitch drive unit 9b, and the first pitch drive control module 91c of the third pitch drive unit 9c. For this reason in the embodiment discussed hereinafter, the pitch system controller 8 unifies the function of a superordinate pitch system controller and monitors the first pitch system control module 81, the first pitch drive control module 91a of the first pitch drive unit 9a, the first pitch drive control module 91b of the second pitch drive unit 9b, and the first pitch drive control module 9c of the third pitch drive unit 9c at the same time.

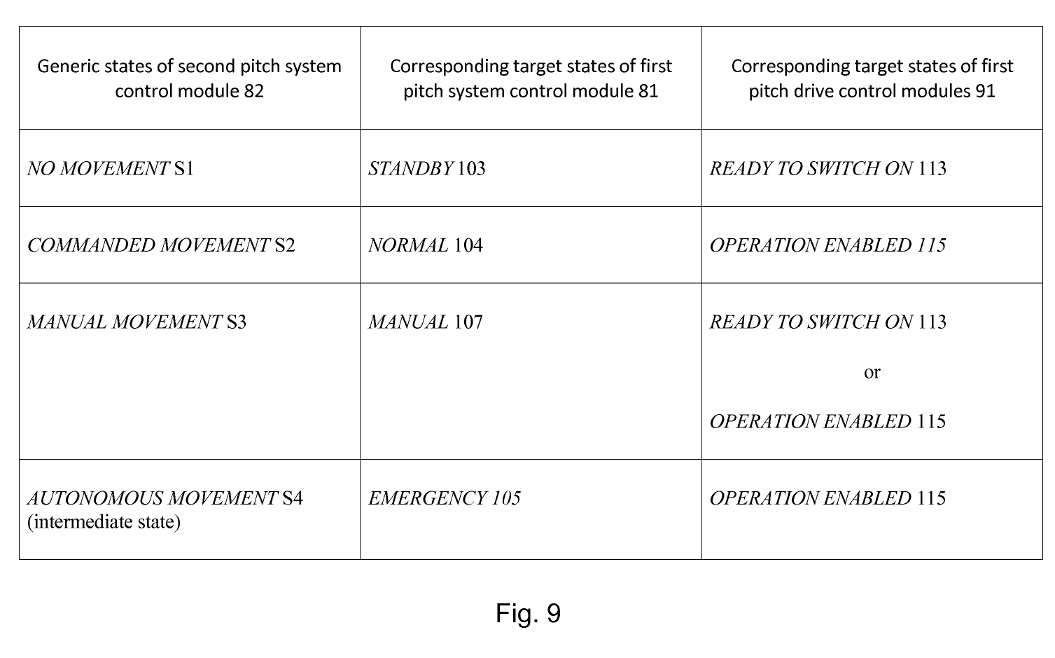

Each of the four safe state of the pitch system controller 8 can be attributed preferably to exact one target state of the first pitch system control module 81 and essentially to one target state of the first pitch drive control module 91 as depicted in the second column of the table depicted in FIG. 9. In generic state NO MOVEMENT S1 the second pitch system control module 82 expects the first pitch system control module 81 to attain the target state STANDBY 103 and expects each first pitch drive control module 91a, 91b, 91c to attain the target state READY TO SWITCH ON state 113. In the event the second pitch system control module 82 transitions to generic state COMMANDED MOVEMENT S2 the second pitch system control module 82 expects the first pitch system control modules 81 to attain the target state NORMAL 104 and expects each first pitch drive control modules 91a, 91b, 91c to attain the target state OPERATION ENABLED 115. In the event the second pitch system control module 82 transitions to generic state MANUAL MOVEMENT S3 the second pitch system control module 82 expects the first pitch system control modules 81 to attain the target state MANUAL 107. The first target state for each first pitch drive control modules 91a, 91b, 91c to attain is READY TO SWITCH ON state 113. In the event the operator wants to run for test purposes the pitch drive units 9a, 9b, 9c in commanded movement the target state of each first pitch drive control modules 91a, 91b, 91c becomes OPERATION ENABLED state 115.

Generic state AUTONOMOUS MOVEMENT S4 is an intermediate state in a transition from generic state COMMANDED MOVEMENT S2 to generic state NO MOVEMENT S1. As the intermediate state AUTONOMOUS MOVEMENT S4 can take considerably longer than the other transitions, it has been assigned as a generic state of its own. This allows to specially monitor this state. The second pitch system control module 82 expects the first pitch system control module 81, once a this transition has been commanded, to attain the target state EMERGENCY 105 in a very short time, for example in less than a second. Then the pitch system 8,9 has to turn all blades from their current position to the feathering position. Depending on the current position of the blades 6a, 6b, 6c this may be as short as some seconds or as long as some thirty seconds. As long as all blades have not arrived in their feathering position the wind turbine 1 is not in a safe state, i.e. the wind turbine may be harmful to persons or objects in the event the wind picks up too heavily so that the blades in their current are stressed to much or the rotor turns too fast. During the so-called feathering run the pitch drives have to be fully operational and therefore the target state for the first pitch drive control modules is the same as for the generic state COMMANDED MOVEMENT S2, i.e. the first pitch drive unit state OPERATION ENABLED 115. Once the blades 6a, 6b, 6c have reached their feathering position, which constitutes the end of the intermediate state AUTONOMOUS MOVEMENT S4, the wind turbine can then quickly transition to generic state NO MOVEMENT S1, which is the safe state for the wind turbine 1.

It depends on the point of view one takes towards the generic states. The transition from generic state COMMANDED MOVEMENT S2 to generic state NO MOVEMENT S1 via generic state AUTONOMOUS MOVEMENT S4 may also be seen as a second transition from generic state COMMANDED MOVEMENT S2 to generic state NO MOVEMENT S1. The monitoring controllers would need to be programmed alternatively to allow for more than just one transition in each direction between two generic states. From a conceptual point of view it may be a less source for errors to allow an extra generic state in favour of having at most one transition for each direction between generic states.

Preferably, in the chosen example, the number of generic states S1, S2, S3, S4 is lower than the number of states of the first pitch system controller 81 and/or the first pitch drive control module 91 in order to reduce the complexity of the monitoring.

In an aspect of the invention each second pitch drive control module 92a , 92b, 92c monitors the state of each associated first pitch drive control module 91a, 91b, 91c that the commanded transitions are attained in time. All three pitch drive control modules 91a, 91b, and 91c are identical in structure. For this reason in the following they are referred to only as pitch drive control module 91. For reason of distinguishing each from each other they just differ in an address for accessing them individually via the fieldbus 801. Also the three second pitch drive control modules 92a, 92b, and 92, each controlling one of the three first pitch drive control modules 91a, 91b, 91c, apart from their field bus addresses, are identical. In order to keep the description concise in the following the monitoring of a first pitch drive control module 91 by a second pitch drive control module 92 is explained as an example for all second pitch drive control modules 92a, 92b, 92c monitoring first pitch drive control modules 91a, 91b, 91c in a wind turbine 1.

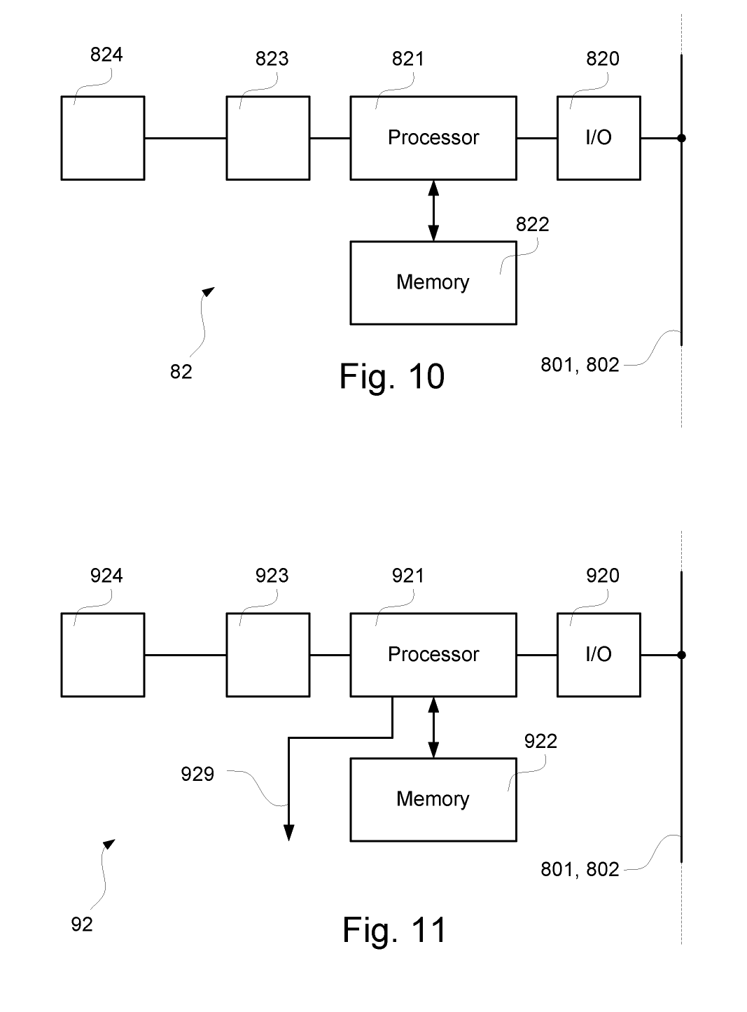

In one aspect of the invention the finite state machine is implemented by software which controls a processor. FIG. 10 for example shows illustrated as a block diagram an embodiment of the finite state machine of a second pitch system control module 82 and components it may comprise. The second pitch system control module 82 comprises one processors 821 and associated memory devices 812 configured to perform a variety of computer-implemented functions such as performing the method steps, calculations and the like and storing relevant data as disclosed herein. The second pitch system control module 82 may be implemented as one or more printed card boards which are plugged into a pitch system controller card board carrier back plane (not shown). A sensor interface 823 permits communication of the processor 821 and a sensor 824. The second pitch system control module 82 also comprises a first field bus interface 820 for communicating on the first field bus 801 with the first pitch drive control module 91 and on the second field bus 802 with the second pitch drive control modules 92a, 92b, and 92c. In this embodiment, the first field bus 801 and the second field bus 802 share the same medium.

FIG. 11 shows illustrated as a block diagram an embodiment of a finite state machine of a second pitch drive control module 92 and components it may comprise. The second pitch drive control module 92 comprises one processor 921 and associated memory devices 912 configured to perform a variety of computer-implemented functions such as performing the method steps, calculations and the like and storing relevant data as disclosed herein. The second pitch drive control module 92 may be implemented as one or more printed card boards which are plugged into a pitch drive controller card board carrier back plane (not shown). A sensor interface 923 permits communication of the processor 921 and a sensor 924. In this specific aspect of the invention the sensor is an absolute angle position sensor positioned at each side of the gearbox that is driving the rotor blade 6a, 6b. The second pitch drive control module 92 also comprises a first field bus interface 920 for communicating on the first field bus 801 with the first pitch drive control module 91 and on the second field bus 802 with the second pitch system control module 82. In this embodiment, the first field bus 801 and the second field bus 802 share the same medium. The second pitch system processor 921 also provides output ports 925 which can be used to overwrite signals of the first pitch drive control module, for example by means of a pulse width signal blocker (not shown) that forces a pulse width signal for controlling the motor to zero.

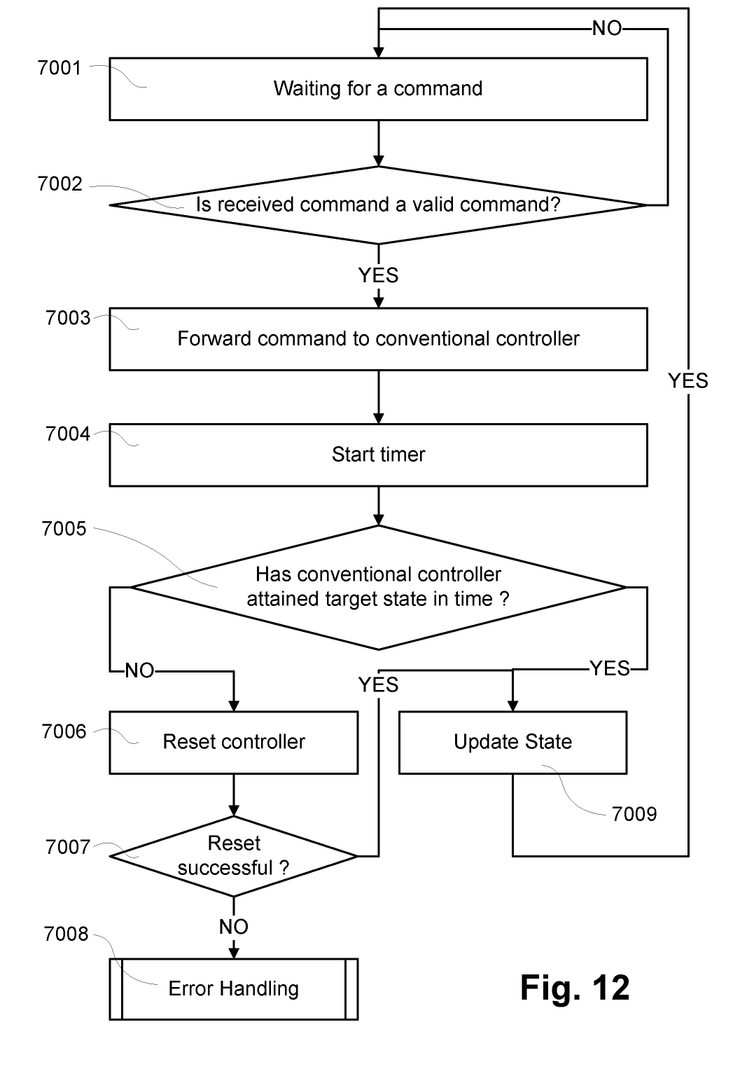

In another aspect of the invention the finite state machine may also implemented completely in wired logic, for example as a field-programmable gate array (FPGA), or a mixture of wired logic and software. FIG. 12 shows the basic steps how a second controller monitors the transition of the first controller from a current state to a target state. These basic method steps may be used by either the second pitch system control module 82 or the second pitch drive control module 92 or both of them.

In an initial method step 7001 the second controller waits to receive a command via one of its interfaces. The command the second controller is waiting for to arrive may originate for example from a superordinate controller. The command may arrive also from a subordinate controller or as a user input. As will be explained in more detail later, in an error situation where one of the three pitch drive modules 91a, 91b, 91c cannot operate its rotor blade any more, and cannot turn it into a neutral position, it may request from the superordinate second pitch system controller 82 that the other two pitch drives execute a feathering run.

Once a command is received as second method step 7002 the command is checked if for the current state of the second controller the received command constitutes a valid command. In the event the received command is not a valid command the command is ignored and the second controller goes back to its initial method step 7001 waiting for a new command to arrive. Optionally the second controller may send as a feedback a warning message that the received command was ignored.

In the event the received command is a valid command the second processor forwards the command in a third method step 7003 to the first processor via for example the first interface. As in this way only valid commands are forwarded to the first processor, the second controller prevents the first controller from receiving commands which could cause the first controller to perform actions which are not included in the restricted set of actions. In the aforementioned aspect of the invention the command received at the second controller is forwarded identically to the first controller. However, as a function of the state of the wind turbine the second controller may be adapted to modify the command before it forwards it to the first controller. For example in case of an error situation it may limit the speed instruction included in a command to a certain portion of the maximum speed, for example 50% of the maximum speed, or reduce the speed, for example to 50% of the speed that is commanded in the received command. One single command can be substituted by one or a sequence of commands. For example instead of forwarding a command to turn the rotor blades to the 90° position, the second controller may send a series of commands to the first controller by which the speed is gradually increased over a first period of time to 50% of the commanded speed, and when the rotor blade has reached a 85° position, the speed is gradually decreased to allow the rotor blade to slowly arrive at the 90° position. By this, instead of forwarding a single speed command, the second controller performs a speed profile. This is especially advantageous in relation to first controllers with very simple design that do not allow by themselves to apply a speed profile or any other kind of profile, such as a profile to limit acceleration, etc.

In an optional fourth method step 7004 the second controller starts an internal timer to monitor the time it takes the first controller from being instructed to transition to the target state to report back that the target state has been attained. In a fifth method step 7005 the second controller now waits for the reception of the status change of the first controller. In some cases, the command sent to the first controller will not change the status of the first controller, in some other cases the sent command is intended to change the status of the first controller to a target state. In case the intended target state is not reported back to the second controller within the prescribed time period, that is known to be the usual time for completing a transition from an actual stated to the target state, the second controller may decide in an optional sixth method step 7006 to reset the first controller and to repeat the command. After a certain number of failed attempts the second controller may decide in a seventh method step 7007 to enter into an error state 7008 and force the wind turbine to pitch its blades 6a, 6b into a feathering position. Alternatively, in an attempt to resetting the first controller, the second controller may just clear the command, so that the first controller returns, or stays, respectively in the state it started from. In case the target state is attained by the first controller in time, the second controller updates its status to the target status in step 7009 and returns back to the initial method step 7001 for waiting for the next command to receive. Optionally the second controller may report the successful completion of the command to a superordinate controller (not shown).

Optionally, for example in the initial method step 7001 and the fifth method step 7005 the second controller may monitor the actions of components of the pitch drive system to verify that the pitch drive system performs certain actions within designed limits. The first controller for example may monitor the action of a motor, for example by means of a limit switch, to ensure that the blades are not turned beyond a certain angle, for example not beyond below an angle of 0° and in the other direction beyond an angle of 90°. In order to improve the safety of the system, the second controller may provide an additional sensor, for example an acceleration sensor, which independently from the sensors used by the first controller checks that the system is operated within the design limits. By this the second controller also checks the plausibility of the actions of the first controller. As a consequence the second controller may generate second control signals 929 which enable the second controller to overwrite control signals generated by the first controller, for example to overwrite control signals that turn the motor.

FIG. 12 shows the basic steps how a second controller monitors the transition of the first controller from a current state to a target state as a reaction to a received command from a superordinate controller. Another option is that the second controller monitors the transition of the first controller from a current state to a target state as a reaction to the change of a signal or a change in the reading of a measurement, of a sensor for example. The change of a signal or the change of a reading is called herein an event.

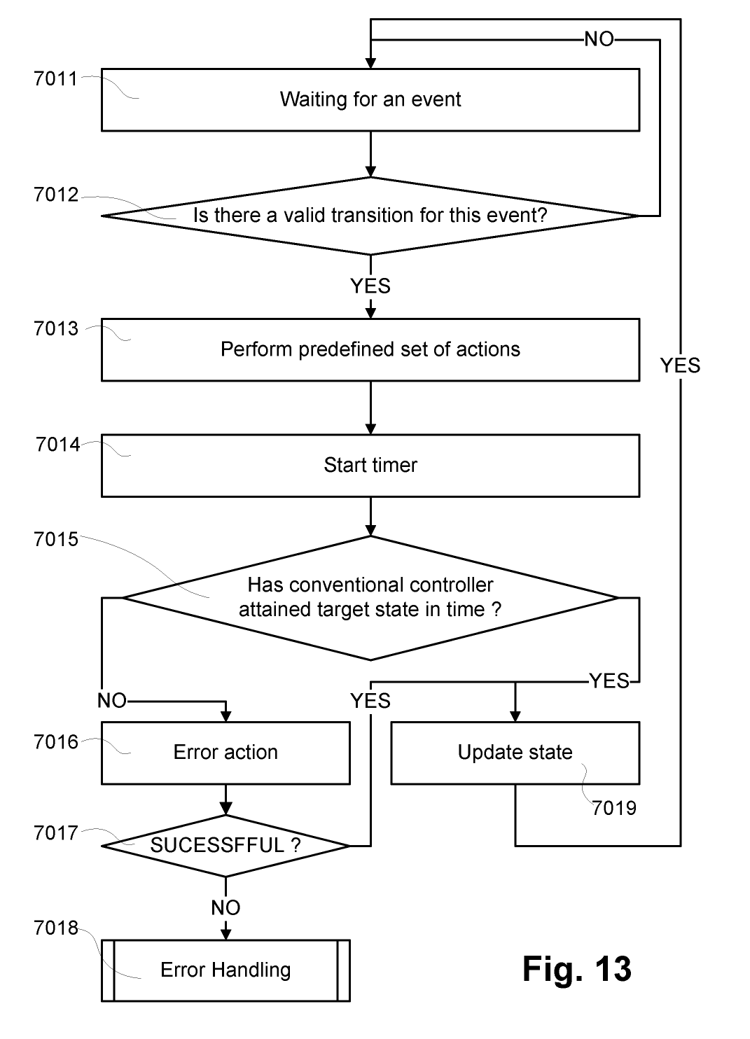

FIG. 13 shows the basic steps how a second controller monitors the transition of the first controller from a current state to a first target state in response to an event.

In a first step 8011 the second controller waits for the event, or actively takes measurements and compares the measurements with at least one predefined threshold value. In a second step 7012 the second controller verifies that there is a predefined transition for the event. In case there is a predefined transition the second controller proceeds in a third step 7013 and performs a predefined action that has been defined for the detected event. Such a predefined action may not only be forwarding a command to the first controller, but also may comprise for example the generation of a control signal, for example. a signal that overwrites an output signal of the first controller, or a control signal that in addition to the action of the first controller activates an additional safety device, for example a brake.

In order to monitor the timely completion of the predefined action the second controller start in the fourth step 7014 a timer and monitors in a fifth step 7015 if the action has been completed in the predefined time. If not optionally an error action 7016 may be performed to save the situation, like resetting the first controller. In case the first controller despite the optional error action 7016 does not complete the predefined action further error handling 7018 may be necessary. In case the predefined action is completed successfully in time the second controller updates in step 7019 the current second state to the second target state and goes back in idling mode to wait for the next event, or the next command.

The embodiment of the invention as a reaction to an input condition was shown in relation to the example of FIG. 12 as a reaction to a received command and in the example discussed in relation to FIG. 13 as a reaction to an event. The person skilled in the art will appreciate that both types of reaction to an input condition (received command and event) may be combined, i.e. the second controller is waiting either for a command to receive or an event to happen. For the sake of intelligibility the method steps have been depicted separately. The person skilled in the art however will appreciate that both examples can be combined so that the second controller reacts to the input condition, or an event, whichever comes first.

In another aspect of the invention the second pitch system control module may use a position encoder with a higher safe integrity level than the encoder that is connected to the pitch drive unit. The second pitch system control module thus can perform a plausibility check of the movement of the motor is within the expected behaviour. As this plausibility check is independent from controlling the motor of a first drive unit 9, it can be used as a limit switch or rotation speed limiter.

After having looked at the basic method steps performed by a second controller let us look now how these steps are applied by the second pitch system control module 82. After the power for the pitch control system 8, 9a, 9b, 9c has been switched and no error has occurred the first pitch system control module 81 advances from POWER ON state 101 via REMAIN state 102 to STANDBY state 103, where the first pitch system control module 81 waits for a command to be received on the first field bus. As according to table 1 the STANBY state 103 of the first pitch system control module 81 corresponds to the target state of NO MOVEMENT state S1 the second pitch system control module 82 by this is in NO MOVEMENT state S1. Similarly, in case no error occurs each first pitch drive control module 91a, 91b, 91c will advance after power is switched on from POWER ON state 110 through the states NOT READY TO SWITCH state 111, SWITCH ON DISABLED state 112 to READY TO SWITCH ON state 113. Each first pitch drive control module 91a, 91b, 91c will remain in this state and wait for a command to be received on the first field bus. According to table 2 the READY TO SWITCH ON state 113 of a first pitch drive control module 91 corresponds to the NO MOVEMENT state S1 of the second pitch drive control module 92. Consequently the second pitch drive control module 92, and as such the pitch drive unit is in NO MOVEMENT state S1. That means that at the end of a successfully completed power up of the pitch system 8, 9a, 9b, 9c, in our embodiment of one pitch system controller 8 and three pitch drive units 9a, 9b, 9c the second pitch system control module 82 and all three second pitch drive control modules 91a, 91b, 91c are in NO MOVEMENT state S1.

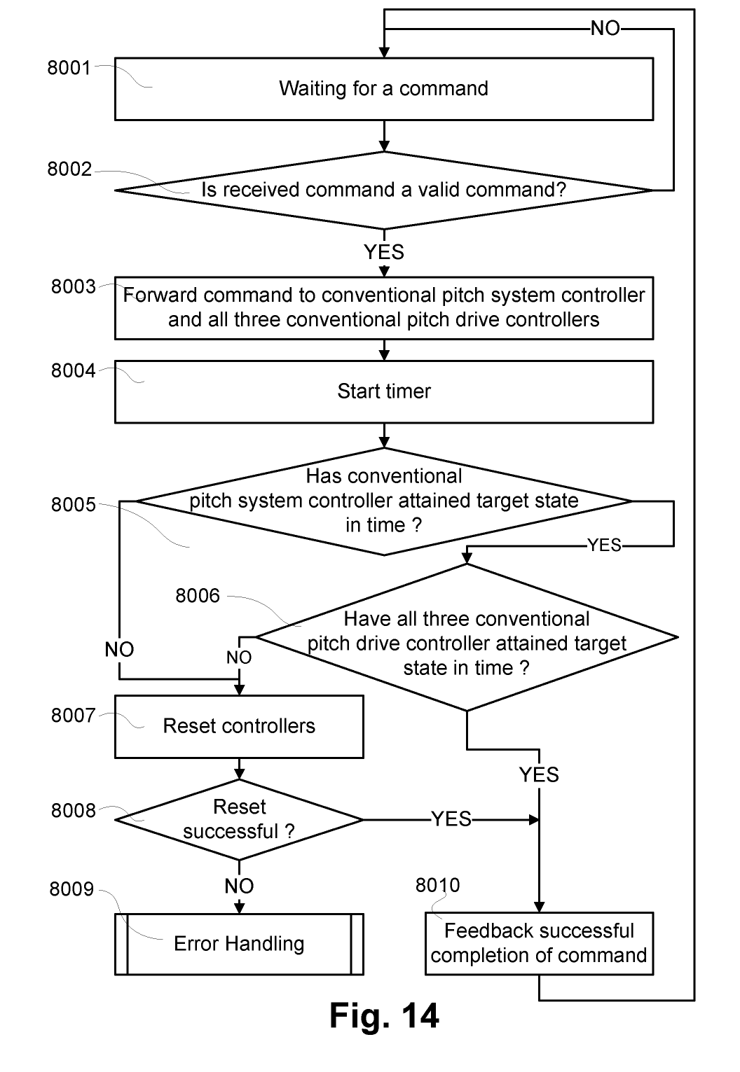

FIG. 14 shows an example how to implement in a pitch system controller 8 the monitoring of the first pitch system controller and the three first pitch drive units 91a, 91b, 91c for the transition from NO MOVEMENT state S1 to COMMANDED MOVEMENT state S2.In the NO MOVEMENT state S1, the second pitch system control module 82 waits for a command to be received (initial pitch system method step 8001) from the wind turbine control unit 7 via the first interface, which is in this embodiment an interface for the first field bus. In this embodiment the second pitch system control module 82 has been assigned the address of the first pitch system control module 81, and the first pitch system control module 81 is identified for example by another individual address. In the specific embodiment of the invention the second pitch controller is implemented as a man-in-the middle between the wind turbine control unit 7 and the first pitch system control module 81 and provides only for a single physical fieldbus interface, which is commonly used by the second pitch system control module 82 and the first pitch system control module 81. Data and commands that are received from the wind turbine control unit 7 are analysed by the second pitch system control module 82. Data and commands originally send to the first pitch system control module 81 are only passed on from the second pitch system control module 82 to the first pitch system control module 82 via an internal interface if it has passed a plausibility check 8002. In case the current state is NO MOVEMENT state S1 according to the allowed transitions as depicted in FIG. 8, only a command NORMAL OPERATION or a trigger event MANUAL OPERATION would be accepted. Any other command or trigger event will be ignored.

As the second pitch system control module 82 passes commands, as far as they are allowed to the first pitch system control module 81, there is no need to change anything in the wind turbine control unit 7. The wind turbine control unit 7 communicates with the second pitch system control module 82 as if it was the first pitch system control module 81. Data or commands generated by the second pitch controller 92 are passed via the internal interface to the common fieldbus interface to be sent to the first pitch drive control module 91. The first pitch drive control module 91a, 91b, 91c however need to be reprogrammed to communicate with the first pitch system control module 81 by means of a new address.

In a third pitch system method step 8003 the second pitch system control module 82 transmits a command COMMANDED MOVEMENT via the second data connection 801 to the first pitch system control module 81 and via the third data connection 802 to the three second pitch drive control modules 92a, 92b, 92c, i.e. the second pitch drive control module 92 of the first pitch drive unit 9a, the second pitch drive control module 92b of the second pitch drive unit 9b, and the second pitch drive control module 92c of the third pitch drive unit 9c. Thus the first pitch system control module 81 receives the command, which it would have received in the conventional embodiment directly from the wind turbine control unit 7, with a detour via the second pitch system control module 82. However, the detour allows the command to be checked for plausibility and thus enhances the safety of the pitch system controller 8.

In the fourth pitch system method step 8004 the second pitch system control module 82 starts a timer for checking that in a fifth pitch system method step 8005 all three second pitch drive control modules 92a, 92b, 92c have reported back to have entered the COMMANDED MOVEMENT state S2 and that in a sixth pitch system method step 8006 the first pitch system control module 81 has reported back that it has attained its target state for the transition from generic state NO MOVEMENT S1 to generic state COMMANDED MOVEMENT S2, i.e. NORMAL state 104. In the pitch system of this embodiment a time limit of one second has proven to be sufficient for attaining the target status. In case either at least one of the three second pitch drive control modules 92a, 92b, 92c does not report back to have entered the COMMANDED MOVEMENT state S2 within the time limit of less than one second or the pitch system control module 81 does not report back that it has attained the NORMAL state 104 within a time limit of less than one second or, the second pitch system module 82 commands in a seventh pitch system method step 8007 by clearing the last command COMMANDED MOVEMENT the first pitch system control module 81 to stay in STANDBY state 104 and commands all three second pitch drive control modules by clearing their last command to return to the NO MOVEMENT state S1. In an eight pitch system method step 8008 the pitch system will perform an adequate action, for example notifying maintenance personal that something went wrong and that the wind turbine awaits in NO MOVEMENT state S1 the arrival of maintenance personnel.

If all commands have been completed successfully in a timely manner the pitch system has successfully transitioned to the COMMANDED MOVEMENT state S2. The second pitch system control module 82 therefore takes the COMMANDED MOVEMENT state S2. Optionally, in case the wind turbine control unit 7 is provided to accept status reports, the second pitch system control module 82 could notify in a ninth pitch system method step 8009 the wind turbine control unit 7 that the pitch system 8, 9 has entered into COMMANDED MOVEMENT state S2. After the ninth pitch system method step 8009 the second pitch system control module 82 loops back to the initial pitch system method step 8001, waiting for the next command to arrive.

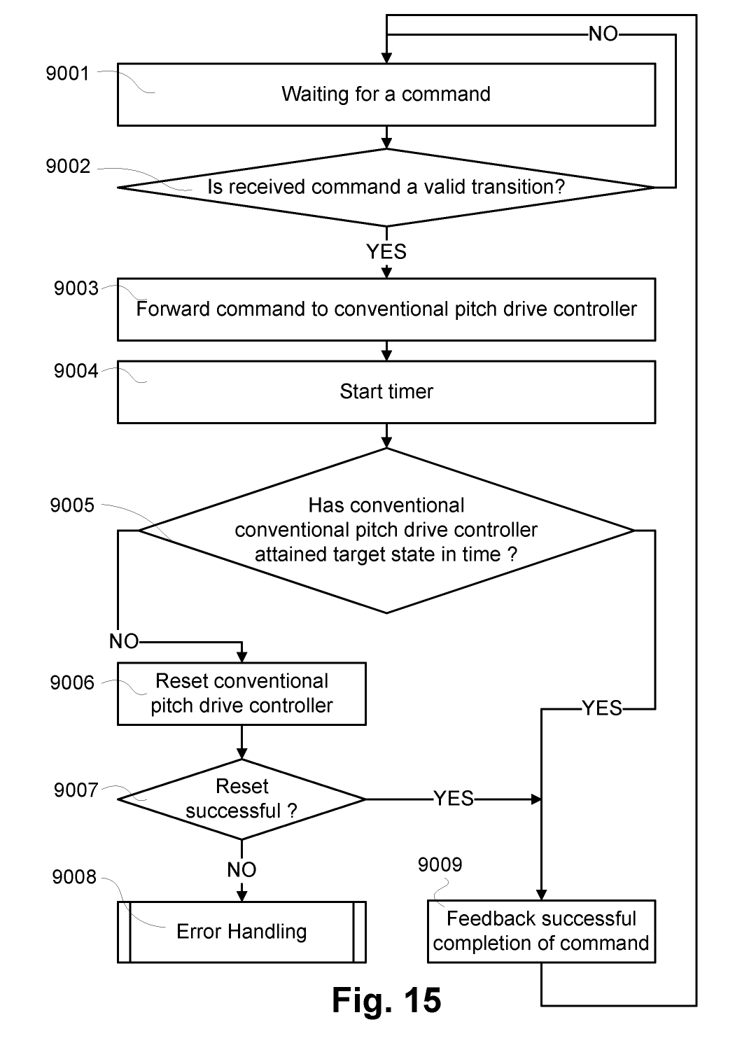

FIG. 15 shows the monitoring of the first pitch drive control module 91 by the second pitch drive control module 92 for the first transition S1→S2 from NO MOVEMENT state S1 to COMMANDED MOVEMENT state S2. In case the first pitch drive control module 91a has not encountered an error, or error conditions have been resolved, the first pitch drive control module 91 will be idling in the READY TO SWITCH ON state 113, which corresponds to the NO MOVEMENT state S1 of the second pitch drive control module 92. In NO MOVEMENT state S1 the second pitch drive control module 92 waits in a first pitch drive method step 9001 for the reception of a command. When the pitch drive control module 92 receives from the second pitch system control module 82 the command to transition to COMMANDED MOVEMENT state S2, it checks in a second pitch drive method step 9002 if the received command is a valid transition from the current state. In order to handle the special situation of a transition via an intermediate generic state, such as the transition from generic state COMMANDED MOVEMENT S2 to generic state NO MOVEMENT S1 via intermediate generic state AUTONOMOUS MOVEMENT S4 the second pitch drive unit module 92 checks in a third pitch drive method step 9003 if the received valid command is a command EMERGENCY RUN. If this is the case the he second pitch drive unit module 92 continues with a fourth and subsequent steps explained in more detail further below. In case the received command is any other valid command such as the command for a transition from NO MOVEMENT state S1 to COMMANDED MOVEMENT state S2 the second pitch drive control module 92 continuous with a fifth step by starting a timer. Concurrently the first pitch drive control module 91 would have received from the first pitch system control module 81 the command ENABLE CONTROL via the first field bus. In case no error occurs the first pitch drive control module 91 will transition automatically to OPERATION ENABLED state 115. The first pitch drive control module 91 then sends its new status over the first field bus so that its change of status can be detected by the second pitch drive control module 92.

In a sixth pitch drive method step 9006 the second pitch drive control module 92 monitors if the first pitch drive control module 91 has reported on the first fieldbus to have attained the OPERATION ENABLED state 115 within the prescribed time limit of less than one second. In case the first pitch drive control module 91 does not attain the target status OPERATION ENABLED state 115 in the prescribed time the second pitch drive control module 92 in a seventh pitch drive method step 9007 clears the last command by sending a CLEAR COMMAND to the first pitch drive control module 91 via the first fieldbus and checks in a eight pitch drive method step 9008 if the clearing of the command was successful. In case the CLEAR COMMAND was unsuccessful the second pitch drive control module 92 based on the severity of the error has to take appropriate action in ninth pitch drive method step 9009. In case the transition was completed successfully the second pitch drive control module 92 sends a feedback to the second pitch system control module 82 in a tenth pitch drive method step 9010

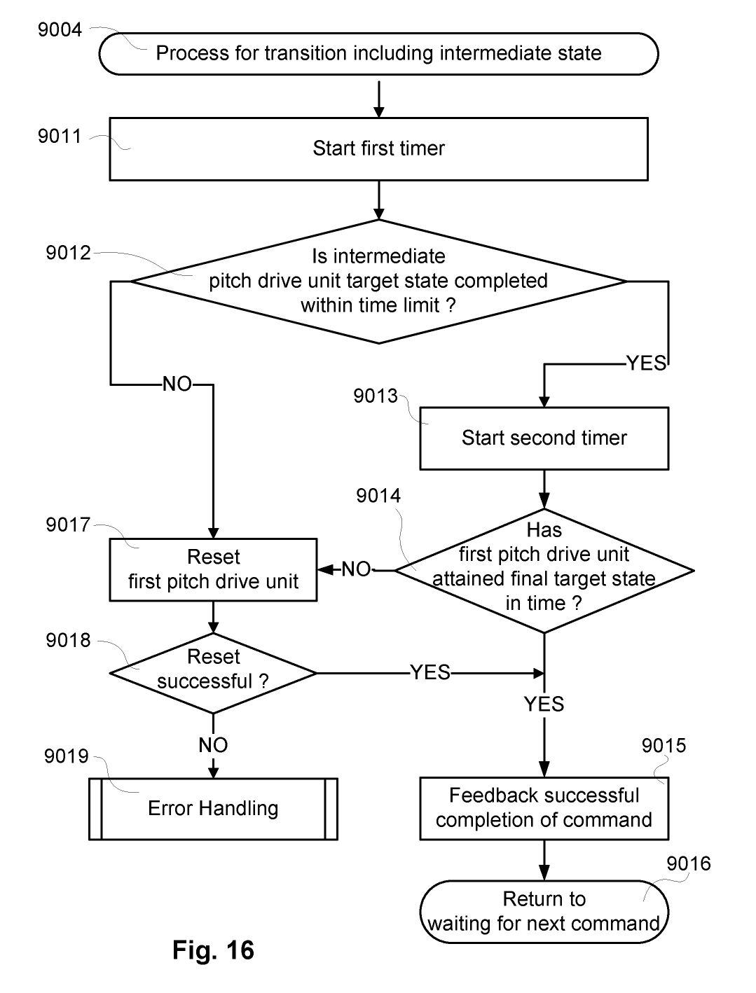

The same steps are performed similarly by the second pitch drive control modules 91 for all other transitions with the exception of the transition from generic state COMMANDED MOVEMENT S2 to generic state NO MOVEMENT S1 via intermediate generic state AUTONOMOUS MOVEMENT S4. The monitoring of this transition is explained in detail on the basis of FIG. 16.

FIG. 16 shows one possible embodiment of how to implement monitoring of the first pitch drive control module 91 especially for the event where the transition to a target state is performed via an intermediate generic state. As for this transition the first pitch drive control module 91 would be already in the intermediate target state READY TO SWITCH ON 113, rather than checking that the intermediate target step has been attained within the prescribed time, the second pitch drive control module 92 checks in a twelfth pitch drive method step 9012 if the first pitch drive control module 91 maintains the OPERATION ENABLED state 115 until all rotor blades 6a, 6b, 6c have returned into feathering position. For this purpose the second pitch drive control module 92 makes use of its own sensor to detect when each rotor blade has attained the respective angle. In case the first pitch drive control module reports back that a blade is in feathering position the second pitch drive control module 92 starts in a thirteenth pitch drive method step 9013 a second timer to monitor if the first pitch drive control module 91 has reported on the first fieldbus to have attained the final target state READY TO SWITCH ON 113 within the prescribed time limit for the second timer of less than one second. In case the first pitch drive control module 91 does not attain the target status READY TO SWITCH ON 113 in the prescribed time the second pitch drive control module 92 in a seventh pitch drive method step 9007 resets in a seventeenth pitch drive method step 9017 the respective first pitch drive unit 91. In case the RESET COMMAND was unsuccessful the second pitch drive control module 92 has to take appropriate action in a nineteenth pitch drive method step 9019. In case the transition was completed successfully the second pitch drive control module 92 sends in a fifteenth pitch drive method step 9015 a feedback to the second pitch system control module 82 and returns to the first method step (FIG. 15) 9001 in order to wait for the next command in generic state NO MOVEMENT 51.

Some state of the pitch system controller and the first pitch drive control modules are not accessible to the operator of the wind machine, but only to service personnel. For example as in the COMMISSIONING MODE state 9 the control software can be updated to a new version, the wind turbine should be prevented from rotating. This state is accessible for service personnel only, and only from POWER ON state 1. This state therefore is not accessible from the standard operator interface. Therefore this state and the transition to and from this state is not included in the second pitch control layer.

While there have been described herein what are considered to be preferred and exemplary embodiments of the present invention, other modifications of these embodiments falling within the scope of the invention described herein shall be apparent to those skilled in the art. So for example it is evident that instead of adapting the second pitch controller 92 to provide for a transition from a first generic state to a second generic state via an intermediate generic state this could alternatively be monitored by the second pitch system control module 82 by monitoring the transition from COMMANDED MOVEMENT state S2 to NO MOVEMENT state S1 as two separate transitions as depicted in FIG. 8, a third transition S2→S4 from COMMANDED MOVEMENT state S2 to AUTONOMOUS MOVEMENT state S4 and a fourth transition S4→S1 from AUTONOMOUS MOVEMENT state S4 to NO MOVEMENT state 51. In this case, instead of the special procedure shown in FIG. 15, the “normal” procedure of FIG. 15 would be performed twice, one after each other. A first time for the third transition S2→S4 from COMMANDED MOVEMENT state S2 to AUTONOMOUS MOVEMENT state S4 and a second time for the fourth transition S4→S1 from AUTONOMOUS MOVEMENT state S4 to NO MOVEMENT state S1.

So far as an aspect of the invention it was described that an end user only sees a limited number of generic states and is allowed only to command a transitions from a first generic state to a second generic state if this transition is part of a pre-defined set of transitions. We have seen that for example the transition from NO MOVEMENT state S1 to COMMANDED MOVEMENT state S2 in fact comprises several sub transitions on pitch drive level, and some of the sub levels on the pitch drive level for good reasons are not accessible to the end user. However, for a service personal, for example it may be convenient to have control over certain sub states on the pitch drive level, but still “hide” some of the levels to the service personal that is on site, as they should not be allowed to access and manipulate all functions, as this may be restricted for repairs in the workshop of the manufacturer of the pitch drive to avoid that the service personal unintentionally may command the pitch drive to perform some actions that may endanger the service personal, bystanders or the pitch drive itself. Another application of generic states and generic sub states is to allow a user to switch his display between two or more different view levels. In case the user of the system wants an overview he switches to the generic state level and is allowed only to command the transitions provided for this level. In case a user wants to finetune the system he may switch to the generic sub state view and is allowed to command the transitions allowed in this level.

A generic state may therefore consist of a set of generic sub states, wherein specific states of the conventional pitch system controller, or the pitch drive control module are attributed as target states to each generic sub state. For example in the NO MOVEMENT state S1 an authorized service personal will see five generic sub states;
a first generic sub state POWER UP B1;
a second generic sub state REMAIN B2;
a third generic sub state STANDBY B3;
a fourth generic sub state BACKUP TEST B4; and
a fifth generic sub state COMMISSIONING B5.

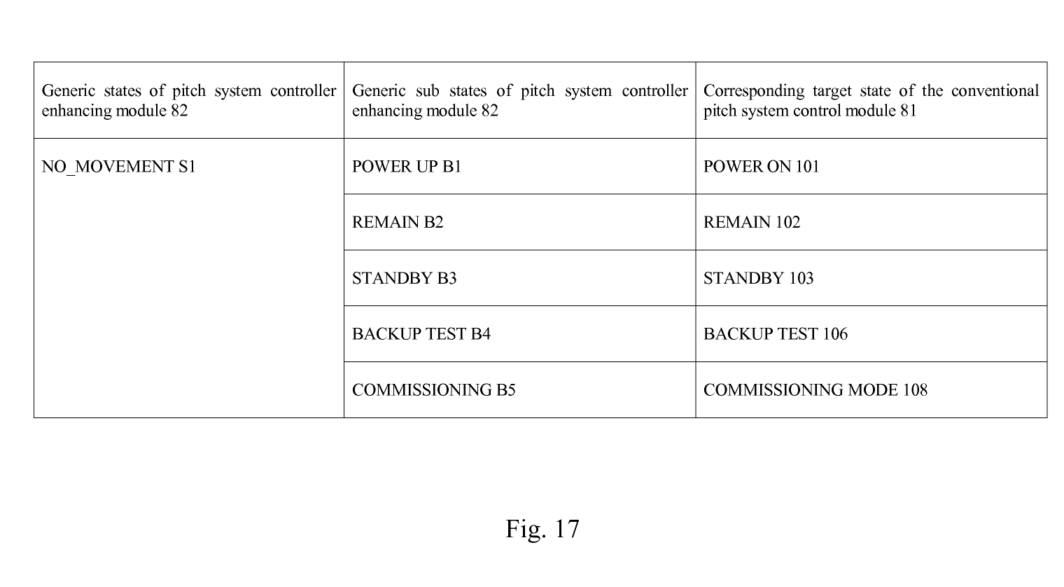

For the generic sub states the attribute “generic” is used to refer to that these sub states are sub states of the generic states S1, S2, S3, and S4. FIG. 17 shows as an example in a first column the generic state NO MOVEMENT S1, in a second column the available sub states for this generic state, i.e. the first generic sub state POWER UP B1, the second generic sub state REMAIN B2, the third generic sub state STANDBY B3, the fourth generic sub state BACKUP TEST B4, and the fifth generic sub state COMMISSIONING B5. A third column of the table of FIG. 17 shows the target states of the enhanced pitch system controller that are attributed to each sub state. Similarly target states of the conventional pitch system controller can be attributed and monitored.

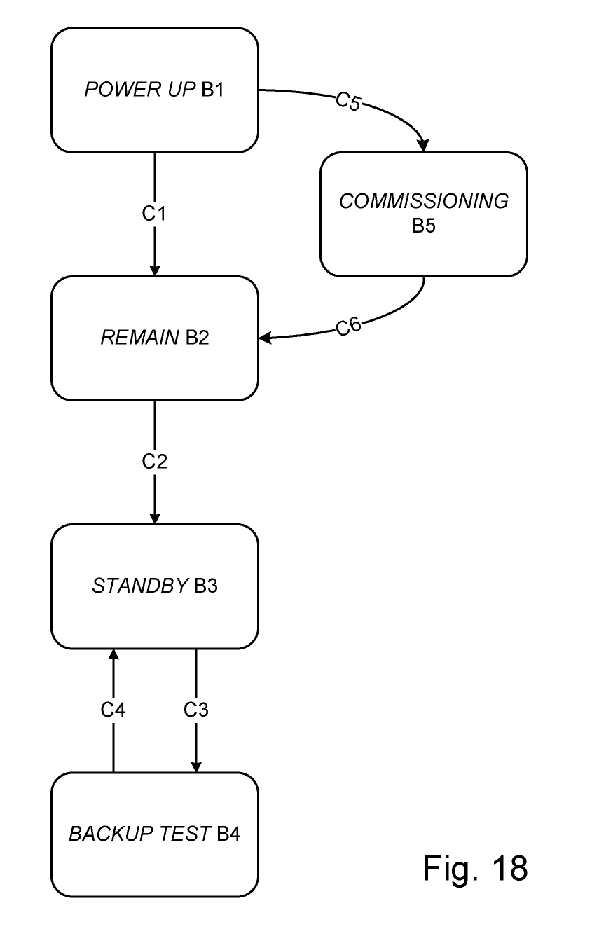

FIG. 18 shows the transitions allowed for a user at the generic sub state level. When powering up the system automatically proceeds in a transition C1 to the generic sub state REMAIN B2, in which case the target state of the system control module is STANDBY 103. In case a user invokes a switch during bootup the pitch system drive will perform instead a transition C5 to COMMISSIONING B5 in which case the target state of the system control module is COMMISSIONING MODE 108 (FIG. 6). Once commissioning is completed the user may confirm that he wants the pitch system controller to advance in transition C6 to generic sub state REMAIN B2 and from there in transition C2 to STANDBY B3. The only transition allowed to BACKUP TEST B4 is C5 from the generic sub state STANDBY B3. The only allowed transition back C6 from generic sub state BACKUP TEST B4 is to STANDBY B3. For all these transitions C1, C2, C3, C4, C5, C6 from one generic sub state to another generic sub state the enhanced system controller can use the same procedures as explained above for checking if the conventional system controller and the pitch drive controller attains the target states within the pre-defined time.

In operation of the wind turbine one or multiple failures may occur. In some wind turbines the pitch motors use a first angle sensor mounted close to an electric motor, for example on the motor shaft. This first angle sensor must be resistant to the heat the electric motor may produce when actuated. The type of angle sensor typically used for this purpose is called a resolver. The most common type of resolver is the brushless transmitter resolver with two two-phase windings, fixed at right angles to each other on a resolver stator, producing a sine and cosine feedback current. The relative magnitudes of the two-phase voltages are measured and used to determine the angle of a resolver rotor relative to the stator. In case a resolver has a single pair of two-phase windings, the feedback signals repeat their waveforms upon one full revolution. Such resolvers typically have a resolution of about 0.1°.

In wind turbines, AC motors were used for pitch drives in the past. However, the trend is to use brushless DC motors. The brushless DC motor is a synchronous electric motor with an electronically controlled commutation system. In a brushless DC motor permanent magnets form the rotor. In order to control the motor an electronic controller distributes the power stator windings such that a rotating magnet field is produced by the stator windings. By the feedback information provided by the resolver the position of the rotor is known and by this the position of the permanent magnets. With this knowledge the motor controller can generate the rotating magnetic field so that the electric motor rotates exactly at the desired speed and torque. If provided with the respective control program a brushless DC motors can be operated without the information from a position sensor, i.e. without the feedback of the resolver at the cost of accuracy. This operation mode is called in the following self-sensing mode. Self-sensing mode could be based on the detection of the Back Electro Magnetic Force (BEMF) induced by the movement of a permanent magnet rotor in front of stator winding. The self-sensing mode analyzes for example zero crossing of BEMF in order to synchronize phase commutations. For lower speeds, where BEMF is small in amplitude the magnetic asymmetry of the motor may be used instead. For example with interior permanent magnet synchronous motors (IPMSM), which are a subcategory of brushless motors, a current sensor may be used to measure a so-called injection current signal. From the injection current signal for example a Kalmanfilter is used to estimate the position of the rotor. Similarly, self-sensing modes are also available for brushed DC motors and synchronous AC motors.

However, in order to control the rotor blades accurately usually the pitch motors are operated with a resolver as a sensor for measuring the angle position of the motor shaft. In case of a failure of the resolver, the motor cannot be controlled accurately and in case of a blade encoder error the position of the rotor blade cannot be measured, risking that the pitch motor turns the rotor blade to the wrong position. To overcome such a situation the invention proposes in case a failure of the resolver is detected but no failure of the blade encoder is detected to switch the motor into self-sensing mode. Additionally the maximum speed can be reduced, for example to half of the rotation speed in sensor mode, to account for the reduced torque in self-sending mode. For example in an emergency situation the rotation speed of the rotor blade may be limited at 6° per second in sensor mode and reduced to 3° per second in self-sensing mode.

As the rotor blade is quite heavy and needs a high torque to be rotated usually a gear box is provided between motor and the tooth ring on which the rotor blade is mounted. Typically the gearbox and a toothed ring that is driven by the gearbox have a transmission ratio of 1:1000 to 1:2000. Taking into account the transmission ratio of the gearbox the position of the rotor blade may be calculated from the resolver data. However, often a second angle decoder is provided at the vicinity of the rotor blade to measure the angle position of the rotor blade. For example in the feathering position the angle of the rotor blades are 90° and in full angle of attack to the wind they are turned substantially into a 0° position. Common angle encoders used for this location have for example a resolution of sixteen bit for a full 360° turn, which results in a resolution of approximately 0.005° . Alternatively twelve or thirteen bit multiturn encoders may be attached to a gear with a ratio of 1:100 to 1:200 which effectively achieves a resolution of effectively up to 0.0002°. Due to their relatively low temperature range such high precision angle decoders cannot be used close to the electrical motor.

In case a blade encoder error is detected the invention proposes to use the resolver information of the pitch motor to calculate the position of the rotor blade. Due to backslash of the gearbox etc. this may not be as accurate as the information from the blade encoder, but it is sufficient to stop the rotor blade at approximately 90°, still avoiding that sufficient lift is produced by the blade to restart to propel the rotor of the wind turbine. As the blade encoder usually produces absolute values, the resolver in contrast hereto usually produces relative values, preferably the pitch drive controller at start-up uses the absolute position provided by the blade encoder to reference the resolver encoder and continuously calculates and compares the resolver position with the blade encoder position. In case of a detected blade encoder failure the device controller can use the continuously calculated position to switch seamlessly from resolver mode into self-sensing mode.

Several other sensors such as a voltage sensor in this embodiment are used as, for example, to measure the capacity of a back-up power supply that is needed in case of a power failure of the generator or the power grid to power the pitch drive motors at least as long as they can turn the rotor blades into the feathering position. In this example, the analysis of the resolver, the blade encoder, and the backup are reduced to a simple binary decision “failure” or “no failure” of the analysed device.

In case a failure of the backup system is detected the invention proposes also to limit the speed of the pitch motor to a second limited speed. This second speed limit takes into account that the backup power supply in this special embodiment is permanently connected to the power supply to support a high current to be drawn by the pitch motor when turning at high speed and high torque. In case of a backup failure this support may not be available and a high speed at a high torque may cause a breakdown of the power supply. In this case it is assumed that it is less risk to pitch the rotor blades at a reduced but constant speed rather than risking a complete halt during a feathering run. This second limited speed may be even lower than for self-sensing mode, for example 2° per second.

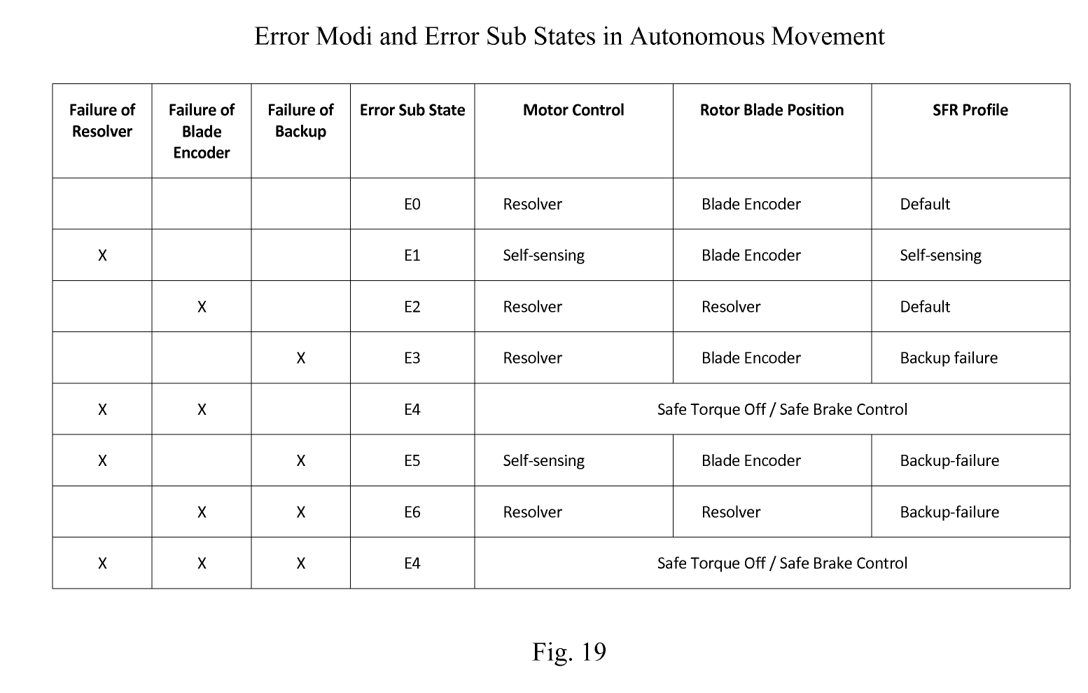

The abovementioned errors may occur in combinations with each other. FIG. 19 shows in a table in a first column the error status of the resolver, whereby a failure of the resolver is indicated by an “X”. Similarly, the second column shows a failure of the blade encoder indicated also by an “X” and a third column shows a failure of the backup system also indicated by an “X”. As with three independent binary events there are eight different possible combinations of the error status of the resolver, the blade encoder, and the backup. The first line after the column headings of the table of FIG. 19 shows the situation where the resolver, the blade encoder and the backup have been analysed to work properly. Consequently, this modus is called “no error” mode E0. In the error free mode E0 the output value of the blade encoder is used by the conventional controller to measure at any time the position of the rotor blade. Once the blade encoder transmits an angle of 90° to the conventional controller, the conventional controller can rely on this input value and will stop rotating the rotor blade when it has reached the final position for the feathering position. As the resolver is assumed to work properly, the enhanced controller controls the motor by using the high resolution data of the resolver. Also, as the back-up power supply does not indicate an error, the commands from the wind turbine controller are transparently forwarded from the enhanced controller to the conventional controller. This is indicated in the table in the column SFR Profile (SFR stands for Safe Feathering Run) by the word “default” which means that the enhanced controller does not apply any modifications to the speed of the motors.

In case a failure of the resolver is detected, this is classified as a first error mode E1. This error mode has been discussed earlier above. As the blade encoder is not affected, the rotor blade position is measured by the blade encoder. The pitch motor, however, is switched from sensor mode, i.e. controlled by the resolver, into self-sensing mode, which also may be called a self-sensing mode. As explained above, the pitch motor speed is limited in the self-sensing mode to a first speed limit. The enhanced controller, in this case, uses an SFR profile which is called “self-sensing”. When the “self-sensing” profile is applied the enhanced controller will modify the received commands so that when they are forwarded to the conventional controller, the speed of the pitch motor is limited to the first speed limit. The limiting of the rotation speed of the pitch motor is just one example. In an SFR profile, other limitations may be applied to the conventional controller, such as maximum current respectively torque limits.

In case a failure of the blade encoder is detected, but resolver and backup are working error-free, this is classified in this embodiment as second error mode E2. As already described above, in this second error mode, the rotor blade position is determined by using the resolver of the pitch motor. As the resolver is not affected, the motor can operate in the usual sensor mode and the SFR profile can remain as the default profile. However, due to the less accurate determined rotor blade position, a profile especially designed for that purpose may be used.

In case the enhanced controller detects a failure of the backup but resolver and blade encoder are indicating to work without errors, a special “backup failure” profile is applied in this embodiment of the invention. As already described above, the backup in the backup failure profile, the speed of the pitch drive is reduced to a second speed limit. However, other alternative or additional measures may be applied by the enhanced controller.

In case a failure of the resolver and a failure of the blade encoder is detected at the same time this is classified as fourth error mode E4. In fourth error mode E4 the invention proposes to prevent any movement by the pitch motor, to engage the mechanical brake and to request the other pitch drives to turn their rotor blades into the feathering position. Usually in wind turbine with three rotor blades it would suffice to have two of the three rotor blades in feathering position to be able to force the wind turbine rotor to a halt. The preventing of any movement can be achieved by resetting any commands received by the enhanced controller to a command that sets the speed to zero, respectively a command that stops the motor. In addition, or alternatively, the enhanced controller may use additional circuitry to block the controls of the pitch motor, for example by interrupting by means of switches the power supply to the a power inverter. Alternatively or in addition hereto all control inputs of the drive circuitry, for example the input lead of an H-bridge can be connected with zero voltage, so that independent whatever control signals are produced in the conventional pitch drive, these control signals are short-circuited to a ground voltage and thus effectively overwritten. Especially the safety of motors without specific safety precautions can be improved with additional circuitry that is controlled for example by second control signals 929 of the second controller 92.

In case the enhanced controller detects the failure of the resolver and a failure of the backup but no failure of the late encoder is classified as error mode E5. In error mode 5, the rotor blade position is directly derived from the blade encoder as the blade encoder is functioned without error. Due to the failure of the resolver, the motor control is set into self-sensing mode and due to the failure of the backup the SFR profile chosen by the enhanced controller is the “backup-failure” profile.

In case the enhanced controller detects the failure of the blade encoder and at the same time the failure of the backup, but the resolver is reported to work without failure, the motor control continues in resolver mode, whereas the rotor blade position is measured by the resolver. Due to the backup failure, the chosen SFR profile is the “backup-failure” profile.

Finally, when the enhanced controller faces a situation where there is a cumulative error of the resolver, the blade encoder, and the backup, the enhanced controller classifies this as an error mode E4, similarly to a cumulative error of the resolver and the blade encoder. The measures taken in this case are safe torque off and safe break control. As in error mode 4, the pitch motor is stopped at once, the SFR profile applied does not matter. Important is only that the enhanced controller is reporting the error E4 to the other pitch drives so that the other pitch drives are commanded into a feathering run. Theoretically, however, the action “Safe Torque Off” may also be seen as a special SFR profile.

As can be seen from FIG. 19, some error modes are not only a pure combination of the measures in case a single failure has occurred. For example, the reaction to a combination of a resolver failure and a blade encoder failure, which is safe torque off, is not equivalent to a combination of error mode E1 and error mode E2. Therefore, the three different types of errors of this embodiment are dealt with in different ways when a combination of errors occurs.

Another advantageous application of a first set of generic states and a second set of generic states is to use the second set of states as a sub set of one of the first set of states. The above introduced error modes are incorporated in the inventive concept of an enhanced controller and a conventional controller as sub states of the AUTONOMOUS MOVEMENT state S4.

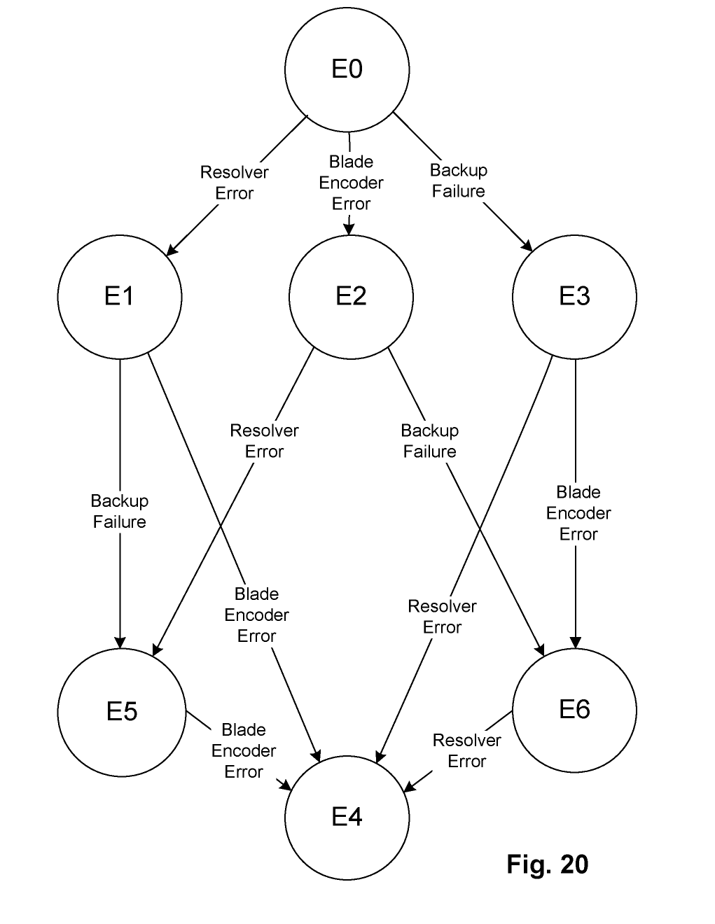

FIG. 20 shows the transitions between the error free state E0 and the first error state E1, the second error state E2, the third error state E3, the fourth error state E4, the fifth error state ES, and the sixth error state E6. An autonomous movement of the rotor blades into the feathering position does not necessarily mean that it was caused by an error. The autonomous movement can also be started intentionally by the user when he wants, for example, to stop the wind turbine for maintenance purposes. In this case, the wind turbine would be in the error free sub-state E0. To stop the wind turbine without the need of an immediate stop in this embodiment a command “Normal Stop” would be used which allows a kind of soft slowing down of the rotor of the wind turbine. This does not only result in little wear of the pitch drives but also a reduction of load for the structure of the wind turbine, such as bending forces on the tower. In “Normal Stop” mode a special profile may be used that slowly turns the rotor blades into the feathering position, for example by limiting the speed to 20% of the maximum speed allowed for the pitch drives.

If no error occurs, the pitch drive stays in error-free sub-state E0 until it has reached the feathering position as planned. In error-free sub-state, as shown in FIG. 20, three error conditions may arise. In case of a resolver error, the pitch drive is adapted to transit to error sub-state E1; in case of a blade encoder failure it will transit to error sub-state E2; and in case of a back-up failure it will transit to error sub-state E3. Even if two failures seem to appear at the same time, the deterministic system will process one of the two or more errors one after the other. In the first error sub-state E1, only two more errors will be evaluated. A blade encoder error will transit the first error sub-state E1 into fourth error sub-state E4 and a backup failure will transit the first error sub-state E1 into the fifth error sub-state E5. Similarly, from second error sub-state E2, a resolver error will transit the pitch drive into the fifth error sub-state E5 and a blade encoder error will transit the second error sub-state E2 into the sixth error sub-state E6. Similarly, a resolver error will transit the third error sub-state E3 into the fourth error sub-state E4 and in case of a backup failure, the pitch drive is transited to sixth error sub-state E6. In case of a blade encoder error, the fifth error sub-state E5 is transited into the fourth error sub-state E4 and in case of a resolver error, the sixth error sub-state E6 is transited into the fourth error sub-state E4. E4 is the ultimate error sub-state as it is only applicable when all three evaluated error conditions have occurred.

As once can see from the transition diagram of FIG. 20, in case an error has occurred, there is no transition back to any of the previous error states as it is too risky to trust a sensor that was reported faulty before. In this case, the pitch drive will have to continue in the once attained error state until a technician has visited the wind turbine and has repaired the cause of the error and/or the error has been reset The described sub-states therefore allow a very clear control of the pitch drive in an error situation. This very clear error handling improves as such the safety of the pitch drive and the wind turbine in total.

### REFERENCE LIST

wind turbine 1
tower 2
nacelle 3
rotor 4
electric generator 5
generator shaft 50
first rotor blade 6a
second rotor blade 6b
third rotor blade 6c
wind turbine control unit 7
first data connection 701
pitch system controller 8
second data connection 801
third data connection 802
pitch drive controller 9
first pitch drive unit 9a
second pitch drive unit 9b
third pitch drive unit 9c
pitch system 8, 9a, 9b, 9c
first interface 810
first pitch system controller processor 811
first pitch system controller memory 812
first pitch system controller sensor interface 813
first pitch system controller sensor 814
second pitch system control module 82
second pitch system controller processor 821
second pitch system controller memory 822
second pitch system controller sensor 824
first pitch drive control module 91
first pitch drive interface 910
first pitch drive processor 911
first pitch drive memory 912
first pitch drive sensor interface 913
first pitch drive sensor 914
pulse width modulator circuit 915
second pitch drive control module 92
second pitch drive interface 920
second pitch drive processor 921
second pitch drive memory 922
second pitch drive sensor interface
second pitch drive sensor 924
second control signals 929
motors, actuators 93a, 93b, 93c
gearboxes 94a, 94b, 94c

1. A method for controlling a machine or a process comprising
a first control unit having a first number of first states and being in a current first state which is one of the number of first states, the first control unit being adapted to transition from the current first state & to another first state of the number of first states in response to a first input condition;
a second control unit for controlling the first control unit, the second control unit having a second number of second states and being in a current second state, the second control unit being adapted to transition from one state of the number of second states to another state of the number of second states in response to a second input condition, the second control unit further comprising:
an attribution list which comprises for each second state of the second control unit an assigned first target state;
a set of predefined transitions between the second states of the second control unit; and
for each predefined transition a set of predefined actions;
the method comprising:
receiving the second input condition indicating the second target state to which the second control unit shall transition from the current second state;
checking if a transition from the current second state to the second target state is included in the set of pre-defined transitions;
in the event the received second input condition is a transition from the current second state to the second target state that is included in the set of pre-defined transitions performing the predefined set of action;
supervising the machine or process if it transits to the first target state; and
in case the machine or process has completed a transition to the target state changing the current second state to the second target state.

2. The method according to claim 1 wherein the input condition is at least one of a command that is received by the second control unit or an event that is sensed by a sensor.

3. The method according to claim 1 wherein the pre-defined action is at least one of transmitting a command to the first control unit which initiates the first control unit to transition to the first target state, modifying a received command before forwarding it to the first control unit, modifying data the first control unit is evaluating, or invoking a control signal that is controlling the first control unit.

4. The method according to claim 1, wherein the first target state is at least one of a state of the number of first states of the first control unit, a state of the number of second states of the second control units, or a reading of a sensor of the machine or process that is within a pre-defined range.

5. The method according to claim 1 further comprising the steps of in case the first control unit does not transition to the target state, initiating a transition to a specific state in which the machine or process is in a safe operational state.

6. The method of claim 1 wherein the second control unit offers at least a first set of second states and a second set of second states which differ from each other.

7. The method of claim 6 wherein at least one of access rights to view and/or control the first set of second states is restricted to a first group of users and access rights to view and/or control the second set of second states is restricted to a second group of users respectively or the view between the first set of second states may be switched between the view of the second set of second states.

8. The method of claims 14 wherein a state of the second control comprises at least two sub states and wherein the second control unit analyses at least one of received commands, received sensor data, or received process data and as a function of the analyses attributes choses one of the sub states as a current sub state.

9. The method of claim 8 wherein for each sub state the second controller modifies or overwrites respectively the commands send to the first controller.

10. The method of claim 9 wherein the at least two sub states represent at least one error free sub state of the machine or process and at least one error status of the machine or process.

11. The method of claim 1 wherein:
the first control unit controls at least a third control unit, the at least third control unit having a third number of third states and being in a current third state which is one of the number of third states, the at least third control unit adapted as a function of a third input condition to transition from the current third state a another third state of the number of third states;
at least a fourth control unit for controlling the at least third control unit, the fourth control unit having a fourth number of fourth states and being in a current fourth state, the fourth control unit adapted as a function of a fourth input condition to transition from one state of the number of fourth states to another state of the number of fourth states, an attribution list in which the method comprising:
to each fourth state of the fourth control unit a third target state is assigned;
a set of predefined transitions between the fourth states of the fourth control unit;
for each predefined transition, a set of predefined actions;
receiving a fourth input condition indicating to which the fourth control unit shall transition from the current fourth state;
checking if a transition from the current fourth state to the fourth target state is included in the set of pre-defined transitions;
in the event the received fourth input condition is a transition from the current fourth state to the fourth target state that is included in the set of pre-defined transitions, performing the predefined set of actions for the current transition;
supervising the at least third control unit if it transits to the third target state;
in case the at least third control unit transited to the target state changing the current fourth state to the fourth target state.

12. The method of claim 11 wherein the first control unit transmits a second command to the at least third control unit as a third input condition.

13. The method of claim 11 wherein each second state of the number of second states corresponds with a fourth state of the number of fourth states.

14. The method of claim 11 wherein the second control unit when by a first input condition initiated to transition to a second target state supervises all of the at least third control units are attaining the corresponding fourth target state.

15. The method of claim 11 where the first and the at least third control unit communicate via a first communication path and the second and the at least fourth control unit communicate via a second communication path and wherein the second communication path is designed such that it complies with the design rules of a safety integrity level that is higher than the safety integrity level of the first communication path.

16. The method of claim 15 where the first and the second communication path are using the same communication medium and that the first communication path is using a first transmission protocol and the second communication path is using a second communication protocol and that the second communication protocol is a protocol with a higher safety integrity level than the first communication protocol.

17. The method of claim 1 wherein the first control unit and the second control unit are a pitch control system controlling the pitch angle of a at least one rotor blade of a wind turbine.

18. The method of claim 11 wherein the third control unit and the fourth control unit are a pitch drive unit for controlling the motor of a wind turbine that turns a rotor blade of a wind turbine.

19. A machine, particularly a wind turbine with a first control unit and a second control unit, wherein the second control unit comprises a processing device which is adapted to carry out the method steps of claim 1.
